(19) United States
(12) Patent Application Publication
(10) Pub. No.: US 2018/0024862 A1
(43) Pub. Date: Jan. 25, 2018

(54) PARALLEL PROCESSING SYSTEM, METHOD, AND STORAGE MEDIUM

(71) Applicant: FUJITSU LIMITED, Kawasaki-shi (JP)

(72) Inventors: Mio NAKAGAWA, Yokohama (JP); Masao HAYAKAWA, Nagakute (JP); Tsuyoshi HASHIMOTO, Kawasaki (JP)

(73) Assignee: FUJITSU LIMITED, Kawasaki-shi (JP)

(21) Appl. No.: 15/586,804

(22) Filed: May 4, 2017

(30) Foreign Application Priority Data
Jul. 25, 2016 (JP) 2016-145711

(51) Int. Cl. G06F 9/50; G06F 9/48

(52) U.S. Cl. CPC G06F 9/5027; G06F 9/4881

(57) ABSTRACT

A parallel processing system includes three or more node devices including a first node device. The first node device is configured to perform an allocation process of a computation resource targeting a processing, the first node device sends permission information to node devices of the three or more node devices, the permission information indicating permission to request the allocation process corresponding in number to a number of processings which the allocation process is able to execute in a unit time using a resource of the first node device in the unit time, the node devices being set to receive an execution request for the processing. The node devices spend the permission indicated by the permission information received from the first node device when receiving the execution request for the processing, and sends a request for execution of the allocation process that targets the processing to the first node device.

### CROSS-REFERENCE TO RELATED APPLICATION

This application is based upon and claims the benefit of priority of the prior Japanese Patent Application No. 2016-145711, filed on Jul. 25, 2016, the entire contents of which are incorporated herein by reference.

### FIELD

The embodiment discussed herein is related to a parallel processing system, a method, and a storage medium.

### BACKGROUND

In the related art, there is a technology of receiving a job execution request and performing a job scheduling process that allocates a computation resource to a received job. Examples of a relevant preceding technology include a technology of referencing job numbers of all information processing apparatuses in response to an input of a new job, searching for an unused number from a unique index range, and registering the number as a new job number. In addition, there is a technology in which a batch server, after information of a job is registered in a database server, calculates the current rate of use from the number of jobs being executed by the batch server and from the maximum number of performable jobs and determines whether to perform processing or to pass processing to another batch server depending on the magnitude of the current rate of use. In addition, there is a technology of calculating and displaying a predicted execution time, a degree of progress of job execution, and a predicted finish time after a user transfers each grouped job as a unit of load balancing from a job registration machine to a job execution machine.

One example of the preceding technology is Japanese Laid-open Patent Publication No. 8-320851, Japanese Laid-open Patent Publication No. 2015-5008, or Japanese Laid-open Patent Publication No. 10-49504.

### SUMMARY

According to an aspect of the invention, a parallel processing system includes: three or more node devices including a first node device, wherein the first node device is configured to perform an allocation process of a computation resource targeting a processing, the first node device includes a memory and a processor, the processor of the first node device is configured to: send permission information to each of a plurality of node devices of the three or more node devices, the permission information indicating permission to request the allocation process corresponding in number to a number of processings which the allocation process is able to execute in a unit time using a resource of the first node device in the unit time, the plurality of node devices being set to receive an execution request for the processing, and the plurality of node devices each include a memory and a processor, each processor of the plurality of node devices is configured to: when receiving the execution request for the processing, spend the permission indicated by the permission information received from the first node device, and send a request for execution of the allocation process that targets the processing to the first node device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an operation example of a parallel processing apparatus according to the present embodiment;

FIG. 2 illustrates a configuration example of an HPC system in a first example;

FIG. 3 illustrates a hardware configuration example of a node;

FIG. 4 illustrates a functional configuration example of the HPC system;

FIG. 5 illustrates one example of a message format;

FIG. 6 illustrates one example of a processing time administration table;

FIG. 7 illustrates one example of a resource ticket usage record administration table;

FIG. 8 illustrates one example of an ID ticket usage record administration table;

FIG. 9 illustrates one example of a resource ticket refill table;

FIG. 10 illustrates one example of a stored content of an ID ticket refill table;

FIG. 11 is a flowchart illustrating one example of an ID ticket initialization process procedure in a scheduler client;

FIG. 12 is a flowchart illustrating one example of a job input process procedure in the scheduler client;

FIG. 13 is a flowchart illustrating one example of a job execution cancelation process procedure in the scheduler client;

FIG. 14 is a flowchart illustrating one example of a job cancelation requesting process procedure in the scheduler client;

FIG. 15 is a flowchart illustrating one example of a job state display process procedure in the scheduler client;

FIG. 16 is a flowchart illustrating one example of a job execution requesting process procedure in the scheduler client;

FIG. 17 is a flowchart illustrating one example of an ID ticket refill requesting process procedure in the scheduler client;

FIG. 18 is a flowchart illustrating one example of a message reception process procedure in the scheduler client;

FIG. 19 is a flowchart illustrating one example of a job execution request message sending process procedure in the scheduler client;

FIG. 20 is a flowchart illustrating one example of an initialization process procedure in a scheduler server;

FIG. 21 is a flowchart illustrating one example of a request message process procedure in the scheduler server;

FIG. 22 is a flowchart illustrating one example of an existing message process procedure in the scheduler server;

FIG. 23 is a flowchart illustrating one example of a ticket invalidity notification process procedure in the scheduler server;

FIG. 24 is a flowchart illustrating one example of a resource ticket refill schedule process procedure in the scheduler server;

FIG. 25 is a flowchart illustrating one example of an ID ticket refill schedule process procedure in the scheduler server;

FIG. 26 is a flowchart illustrating one example of a computation resource allocation process procedure in the scheduler server;

FIG. 27 is a flowchart illustrating one example of a processing time estimation formula recording process procedure in the scheduler server;

FIG. 28 is a flowchart illustrating one example of a resource ticket usage record recording process procedure in the scheduler server;

FIG. 29 is a flowchart illustrating one example of a ticket administration process procedure in the scheduler server;

FIG. 30 is a flowchart illustrating one example of a resource ticket issue number calculation process procedure in the scheduler server;

FIG. 31 is a flowchart illustrating one example of a resource ticket issue number estimation error correction process procedure in the scheduler server;

FIG. 32 is a flowchart illustrating one example of a resource ticket distribution process procedure in the scheduler server;

FIG. 33 is a flowchart illustrating one example of an ID ticket usage record recording process procedure in the scheduler server;

FIG. 34 is a flowchart illustrating one example of an ID ticket issue number calculation process procedure in the scheduler server;

FIG. 35 is a flowchart illustrating one example of an ID ticket distribution process procedure in the scheduler server; and

FIG. 36 illustrates a configuration example of an HPC system in a second example.

### DESCRIPTION OF EMBODIMENT

According to a technology in the related art, if job execution requests are concentrated in a short period, load on an apparatus performing a scheduling process is increased. If the load on the apparatus performing a job scheduling process is increased to reach an upper limit of the number of job execution requests, job execution requests are not performed.

In one aspect, an object of the present embodiment is to reduce a job execution request not being performed.

Hereinafter, the present embodiment will be described in detail with reference to the drawings.

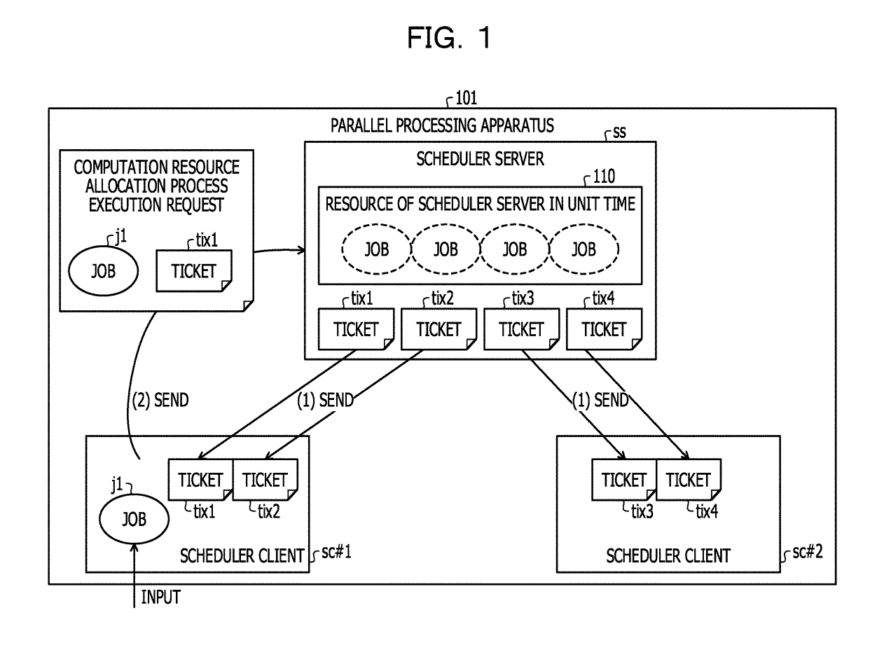

FIG. 1 illustrates an operation example of a parallel processing apparatus according to the present embodiment. A parallel processing apparatus 101 is a computer that executes a job scheduling process. For example, the parallel processing apparatus 101 has three or more nodes that have processors and memories. A plurality of nodes of the three or more nodes performs a scheduling process in cooperation with a specific node. An execution entity that executes a job may be any node of the three or more nodes included in the parallel processing apparatus 101 or may be another apparatus other than the parallel processing apparatus 101. In description below, the execution entity that executes a job is a computation node of the three or more nodes included in the parallel processing apparatus 101.

A job represents a unit of processing viewed from a user of the parallel processing apparatus 101. Examples of a concept similar to the job include a process that is an execution unit of a program and has a unique memory space, a thread that is an execution unit of a program and shares a memory space with a thread belonging to the same process, and the like. Therefore, the parallel processing apparatus 101 may perform a scheduling process for a plurality of threads or a plurality of processes as a plurality of jobs. The job is a job of a process such as scientific technical computation. In addition, the parallel processing apparatus 101 is a computer that is used in the field of, for example, high performance computing (HPC).

Generally, requesting a job scheduler to execute a job may be referred to as “inputting a job” or “a job input” in a parallel computer environment. In execution of parallel jobs, as a scheduling process, computation devices that are units of allocation to a job, such as processors, cores, or computation nodes, are allocated in numbers previously specified by an inputter of a job in a batched manner for a specified length of time.

A set of computation nodes that are reserved for execution of a previously received job is used for executing the job in a reserved time slot. That is, a set of “a set of computation nodes” and a “time slot” may be regarded as being allocated to the previously received job. After inputting a job, the user of the parallel processing apparatus 101, in many cases, confirms a resource allocated to the job, particularly, an estimated execution start time of the job. In addition, “a set of computation nodes” and a “time slot” specified by each job are different. Thus, there may be an increase in the amount of processing of performing a job scheduling process for a large parallel computer in order to increase the operating rate of the computation device in the entire system to the extent possible. Particularly, in the case of use mainly in execution of small or medium jobs, these jobs, in many cases, are input from user terminals that are work environments of an unspecified number of users. Thus, multiple job inputs may occur in a comparatively short amount of time.

Examples of occurrence of multiple job inputs in a comparatively short amount of time include the case of a large number of users coincidentally inputting multiple jobs in a comparatively short amount of time and the case of a specific user executing a shell script that automatically inputs multiple jobs. For the automatic input of multiple jobs by a shell script, the input jobs are canceled in many cases due to the cause of error in the script.

For example, if a job scheduling process is performed in a certain apparatus, reception of a job is rejected in the case of occurrence of load that exceeds the processing performance of the apparatus, and a job input process results in error. In addition, there exists a user who tries to finish the job earlier by trial and error by changing the specification of the number of computation nodes, and such an action is the cause of increasing job inputs. The reason for changing the specification of the number of computation nodes is that if the number of computation nodes specified is changed, the “time slot” which is the allocated resource, that is, the start time and the end time of the job, may be changed according to the resource allocation status of another job.

If such a cause increases load on the apparatus that executes a job scheduling process, the number of receivable jobs is decreased, and job inputs may result in more errors. As a method for avoiding a job input from resulting in error in the case of execution of multiple job inputs being concentrated in a short amount of time, the apparatus that executes the job scheduler may have sufficient processing performance. However, this method causes a number of unused devices to operate at all times when the number of job inputs is at a general level and is not reasonable in many cases from the viewpoint of cost.

Therefore, in the present embodiment, the execution entity that performs a scheduling process is divided into a plurality of clients receiving job inputs and a server allocating a computation resource to a received job. The server distributes, to the clients, permission information that indicates permission to make requests corresponding in number to jobs subjectable to an allocation process by the server. The client spends the permission information to request the server to perform processing of allocating a computation resource to the job.

In description below, of execution entities performing a scheduling process, a node that is the server will be referred to as a “scheduler server”, and a node that is the client will be referred to as a “scheduler client”.

The permission information may include job identification information that is assigned to a job subjectable to an allocation process by the permission indicated by the permission information. In description below, the permission information will be referred to as a “ticket”. In addition, the job identification information will be referred to as a “job identifier (ID)”. One constraint that is to be followed in a system using a job is assigning a unique job ID in the entire system to an input job and notifying the job ID to the input source of the job. If the job ID is included in a ticket, the scheduler client, if receiving a job input in a state of not having a ticket, may not set the job ID for the received job. Therefore, in the present embodiment, the above ticket may be divided into a “resource ticket” indicating permission to request the server to perform processing of allocating a computation resource and an “ID ticket” having the job ID. In this case, the scheduler server may previously distribute the ID ticket to the clients.

An operation example of the parallel processing apparatus 101 will be described by using FIG. 1. The parallel processing apparatus 101 illustrated in FIG. 1 has scheduler clients sc#1 and sc#2 receiving a job input and a scheduler server ss which is a specific node performing an allocation process of a computation resource. In addition, the ticket illustrated in FIG. 1 includes the resource ticket and the ID ticket. In addition, an allocation process of a computation resource will be referred to as a “computation resource allocation process” below.

As illustrated by (1) in FIG. 1, the scheduler server ss uses a resource thereof in a unit time to distribute, to the scheduler clients sc#1 and sc#2, tickets tix that correspond in number to jobs subjectable to the computation resource allocation process in the unit time. In the example in FIG. 1, the resource of the scheduler server ss in the unit time is illustrated by a rectangle 110. Four jobs that have edges of broken lines in the rectangle 110 in FIG. 1 indicate that the number of jobs subjectable to the computation resource allocation process in the unit time is four. The unit time may be any time interval and is, for example, a few seconds.

In the example in FIG. 1, the scheduler server ss generates four tickets tix1 to tix4 that correspond in number to the jobs subjectable to the computation resource allocation process in the unit time. Next, the scheduler server ss allocates the tickets tix1 and tix2 to the scheduler client sc#1 and allocates the tickets tix3 and tix4 to the scheduler client sc#2. The scheduler server ss sends the allocated ticket tix to the scheduler clients sc#1 and sc#2. In addition, the scheduler server ss may set approximately a few seconds of a valid time for the ticket. The ticket for which the valid time elapses is invalidated.

In addition, allocating the ticket tix to each scheduler client sc and sending the allocated ticket tix to the scheduler client sc may be referred to as “distributing the ticket to each scheduler client sc”. In addition, the proportions of the ticket tix distributed to each scheduler client sc may be any proportions. For example, the scheduler server ss may evenly distribute the ticket tix to each scheduler client sc or may distribute the ticket tix according to the processing performance of each scheduler client sc. Alternatively, the scheduler server ss may distribute the ticket tix according to the number of requested tickets from the scheduler client sc.

As illustrated by (2) in FIG. 1, the scheduler client sc, in the case of receiving a job input, spends the ticket tix to send, to the scheduler server ss, a request for execution of the computation resource allocation process that targets the received job. In the example in FIG. 1, the scheduler client sc receives an input of a job j1 from the user of the parallel processing apparatus 101. In this case, the scheduler client sc spends the ticket tix1 to send, to the scheduler server ss, a request for execution of the computation resource allocation process that targets the job j1. Accordingly, the parallel processing apparatus 101 may reduce load exerted on the scheduler server ss to a certain extent and may reduce the number of job inputs executed by the user reaching an upper limit.

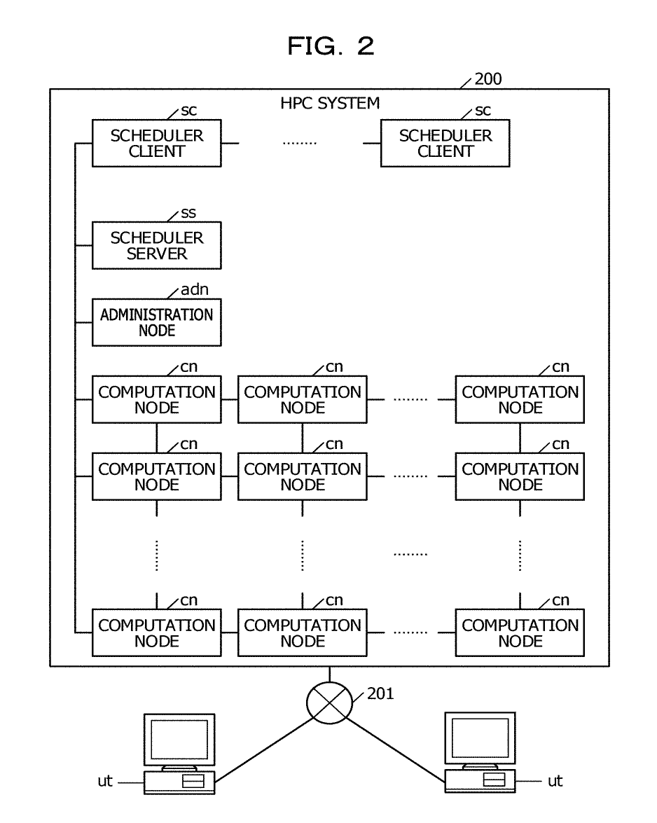

While the scheduler server ss in the example in FIG. 1 generates the tickets tix corresponding in number to the jobs subjectable to the computation resource allocation process in the unit time, the scheduler server ss may generate a different number of tickets. For example, in the case of a large number of jobs being subjectable to the computation resource allocation process in the unit time and an excessively large number of tickets tix being generated, the scheduler server ss may generate tickets in numbers acquired by dividing the number of jobs subjectable to the computation resource allocation process in the unit time by an integer greater than or equal to two. The scheduler client sc may spend the distributed ticket to send, to the scheduler server ss, a request for execution of the computation resource allocation process for jobs corresponding in number to the above integer. Next, an example of the case of applying the parallel processing apparatus 101 to an HPC system will be described by using FIG. 2.

FIG. 2 illustrates a configuration example of an HPC system in a first example. An HPC system 200 illustrated in FIG. 2 has a plurality of the scheduler clients sc, the scheduler server ss, an administration node adn, and a plurality of computation nodes cn. In addition, the HPC system 200 is connected, via a network 201 such as the Internet, to a user terminal ut that is operated by a user using the HPC system 200.

A job scheduling process in the HPC system 200 is processed by cooperation between the scheduler client sc and the scheduler server ss. The scheduler client sc and the scheduler server ss may be any nodes in the HPC system 200.

The administration node adn is a node that administers the entirety of the HPC system 200. The computation node cn is a node that executes a job. A resource of the computation node cn is a computation resource that is allocated to a job.

The user terminal ut inputs a job into the HPC system 200. The input job is received by any of the plurality of scheduler clients sc.

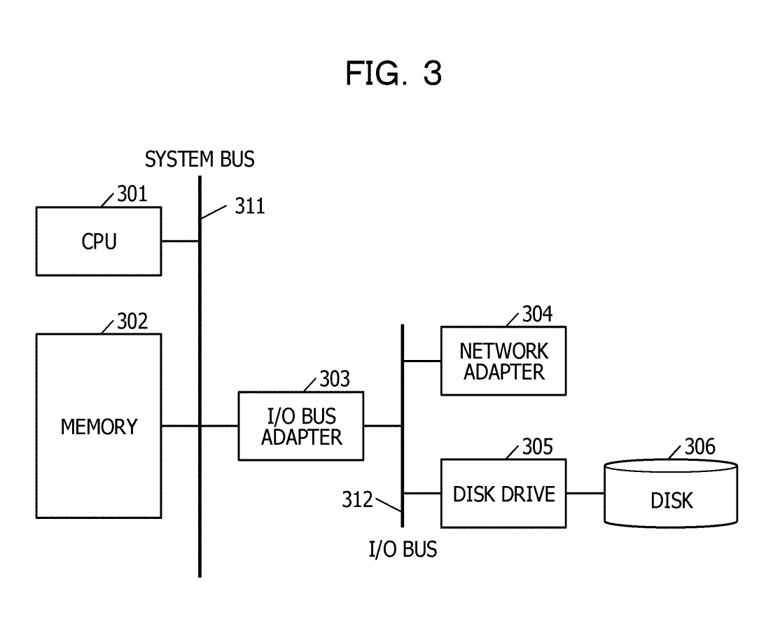

Next, a hardware configuration example of a node that collectively refers to the scheduler client sc, the scheduler server ss, the administration node adn, and the computation node cn will be described with FIG. 3.

FIG. 3 illustrates a hardware configuration example of a node. The node has a central processing unit (CPU) 301, a memory 302, an input/output (I/O) bus adapter 303, a network adapter 304, a disk drive 305, and a disk 306. The CPU 301, the memory 302, and the I/O bus adapter 303 are connected to each other by a system bus 311. In addition, the I/O bus adapter 303, the network adapter 304, and the disk drive 305 are connected to each other by an I/O bus 312.

The CPU 301 is an operation processing device that controls the entirety of the node. The memory 302 includes a non-volatile memory storing a program such as a boot program and a volatile memory used as a work area of the CPU 301. In addition, a job scheduling program in the first example may be stored in the non-volatile memory.

The I/O bus adapter 303 is a device that mediates connection of the CPU 301 to the I/O bus 312. The network adapter 304 is connected to a network and is connected to another device in the HPC system 200 or to the user terminal ut through the network.

The disk drive 305 is a control device that controls reads and writes of data on the disk 306 in accordance with control of the CPU 301. For example, a magnetic disk drive, an optical disk drive, or a solid state drive is preferably employed in the disk drive 305. The disk 306 is a non-volatile memory that stores data written under control of the disk drive 305. For example, in the case of the disk drive 305 being a magnetic disk drive, a magnetic disk is preferably employed in the disk 306. In addition, in the case of the disk drive 305 being an optical disk drive, an optical disk is preferably employed in the disk 306. In addition, in the case of the disk drive 305 being a solid state drive, a semiconductor memory formed of a semiconductor element, a so-called semiconductor disk, is preferably employed in the disk 306.

In the case of an administrator of the HPC system 200 directly operating, for example, the administration node adn, the administration node adn may have hardware such as a display, a keyboard, and a mouse in addition to the hardware illustrated in FIG. 3. In addition, the user terminal ut has a CPU, a memory, an I/O bus adapter, a network adapter, a disk drive, a disk, a display, a keyboard, and a mouse.

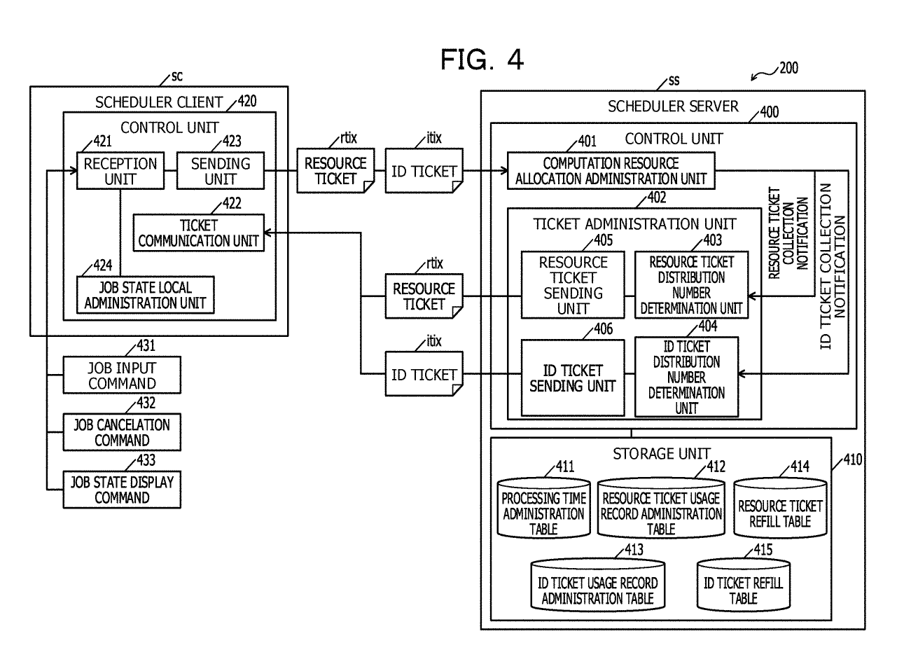

FIG. 4 illustrates a functional configuration example of the HPC system. The scheduler server ss has a control unit 400. The control unit 400 includes a computation resource allocation administration unit 401 and a ticket administration unit 402. The ticket administration unit 402 has a resource ticket distribution number determination unit 403, an ID ticket distribution number determination unit 404, a resource ticket sending unit 405, and an ID ticket sending unit 406. The control unit 400 realizes the function of each unit by the CPU 301 executing a job scheduler program stored in a storage device. The storage device is, for example, the memory 302 illustrated in FIG. 3. In addition, the processing result of each unit is stored in a register of the CPU 301, a cache memory of the CPU 301, or the like.

In addition, the scheduler server ss has a storage unit 410. The storage unit 410 is the memory 302 and the disk 306. The storage unit 410 has a processing time administration table 411, a resource ticket usage record administration table 412, an ID ticket usage record administration table 413, a resource ticket refill table 414, and an ID ticket refill table 415.

In addition, the scheduler client sc has a control unit 420. The control unit 420 has a reception unit 421, a ticket communication unit 422, a sending unit 423, and a job state local administration unit 424. The control unit 420 realizes the function of each unit by the CPU 301 executing the job scheduler program stored in the storage device. The storage device is, for example, the memory 302 illustrated in FIG. 3. In addition, the processing result of each unit is stored in the register of the CPU 301, the cache memory of the CPU 301, or the like.

In addition, the scheduler client sc receives a job input command 431, a job cancelation command 432, and a job state display command 433 from the user terminal ut. The job input command 431 is a command that inputs a job. The job cancelation command 432 is a command that cancels execution of a job. The job state display command 433 is a command that acquires the state of a job and displays the acquired state on the user terminal ut. The job cancelation command 432 and the job state display command 433 include the job ID that is notified to the user terminal ut at the time of response to the job input command 431.

The scheduler server ss and the scheduler client sc may be any nodes in the HPC system 200. For example, the administrator of the HPC system 200 may specify the scheduler server ss and the scheduler client sc from nodes in the HPC system 200. In the case of a certain node in the HPC system 200 being specified as the scheduler server ss, the node has the control unit 400 and the storage unit 410. In addition, in the case of a certain node in the HPC system 200 being specified as the scheduler client sc, the node has the control unit 420.

The computation resource allocation administration unit 401 administers allocation of a computation resource. For example, the computation resource allocation administration unit 401 executes the computation resource allocation process that targets a job received from the scheduler client sc. In addition, for a resource ticket rtix and an ID ticket itix received along with the job received from the scheduler client sc, the computation resource allocation administration unit 401 sends a resource ticket collection notification and an ID ticket collection notification to the ticket administration unit 402.

The ticket administration unit 402 administers the resource ticket rtix and the ID ticket itix. The resource ticket distribution number determination unit 403 determines the number of resource tickets rtix to be distributed to the scheduler client sc. For example, the resource ticket distribution number determination unit 403 may use, as the number of resource tickets rtix to be distributed to the scheduler client sc in a unit time subsequent to a certain unit time, the number of jobs that are targets at the time of performing the computation resource allocation process in the certain unit time.

In addition, as another method, assume that the computation resource allocation administration unit 401 executes the computation resource allocation process in a certain unit time. In response to the execution of the computation resource allocation process, the resource ticket distribution number determination unit 403 stores, in the processing time administration table 411, the number of nodes executing each job of processing targets, a time slot of execution of each job, and the amount of time taken for the allocation process that targets each job.

Next, the resource ticket distribution number determination unit 403 specifies each job that is a target of the computation resource allocation process executed after the certain unit time. Each job is specified from a request for the computation resource allocation process received from the scheduler client sc. The resource ticket distribution number determination unit 403 references the processing time administration table 411 and specifies, based on the number of nodes executing each specified job and the time slot of execution of each job, the amount of time taken for the computation resource allocation process that targets each job. For example, the resource ticket distribution number determination unit 403 may reference the processing time administration table 411 and perform multiple regression analysis with the number of nodes and the time slot as explanatory variables and the amount of time taken for the computation resource allocation process as an explained variable. The resource ticket distribution number determination unit 403 inputs the number of nodes executing each specified job and the time slot of execution of each job into a model acquired by multiple regression analysis and thereby specifies the amount of time taken for the computation resource allocation process that targets each job.

In addition, the explanatory variable is not limited to the number of nodes executing jobs and the time slot of execution of jobs. For example, the resource ticket distribution number determination unit 403 may add the number of jobs previously subjected to the computation resource allocation as an explanatory variable. In addition, the explanatory variable may be any one of the number of nodes executing jobs and the time slot of execution of jobs.

The resource ticket distribution number determination unit 403 determines the number of jobs subjectable to the allocation process in a unit time after the certain unit time based on the amount of time taken for the allocation process that targets each specified job. The unit time after the certain unit time may be a unit time subsequent to the certain unit time or may be a unit time subsequent to a unit time subsequent to the certain unit time.

The ID ticket distribution number determination unit 404 determines the number of ID tickets itix to be distributed to the scheduler client sc. For example, the ID ticket distribution number determination unit 404 may use, as the number of ID tickets itix to be distributed to the scheduler client sc in a unit time subsequent to a certain unit time, the number of jobs that are targets at the time of performing the computation resource allocation process in the certain unit time.

The resource ticket sending unit 405 uses a resource thereof in the unit time to distribute, to each scheduler client sc, the resource tickets rtix that correspond in number to the jobs subjectable to the allocation process in the unit time. The number of resource tickets rtix may be a value previously determined by the administrator of the HPC system 200 or may be a value determined by the resource ticket distribution number determination unit 403.

The ID ticket sending unit 406 distributes the ID ticket itix to each scheduler client sc. The number of ID tickets itix may be a value previously determined by the administrator of the HPC system 200 or may be a value determined by the ID ticket distribution number determination unit 404.

The reception unit 421 receives the job input command 431, the job cancelation command 432, and the job state display command 433. For example, the reception unit 421, in the case of receiving the job input command 431, stores information of the input job in a request queue. The request queue stores a job that is received from a user terminal and for which an execution request for the computation resource allocation process is not yet sent to the scheduler server ss.

The ticket communication unit 422 receives the resource ticket rtix and the ID ticket itix from the scheduler server ss.

The sending unit 423, in the case of receiving a job execution request by the job input command 431, spends the resource ticket rtix to send, to the scheduler server ss, a request for execution of the computation resource allocation process that targets the received job.

In addition, the sending unit 423, in the case of receiving a job execution request by the job input command 431, allocates the job ID of the ID ticket to the received job and sends the allocated job ID to the user terminal that is the source of the job input. The sending unit 423 spends the resource ticket rtix to send, to the scheduler server ss, a request for execution of the computation resource allocation process that targets the job identified by the allocated job ID.

The job state local administration unit 424 administers the local state of a job. For example, the job state local administration unit 424 references the request queue and determines whether or not an execution request for the computation resource allocation process that targets a job assigned a certain job ID is sent to the scheduler server ss.

In addition, assume that the reception unit 421 receives a cancelation request for the job including the job ID by the job cancelation command 432. In this case, the job state local administration unit 424 determines whether or not an execution request for the computation resource allocation process that targets the job is sent to the scheduler server ss. In the case of determining that an execution request for the allocation process that targets the job is not sent to the scheduler server ss, the job state local administration unit 424 discards a request for execution of the allocation process that targets the job. For example, the job state local administration unit 424 discards information of the job from the request queue. In the case of determining that an execution request for the allocation process that targets the job is previously sent to the scheduler server ss, the job state local administration unit 424 sends a job cancelation request to the scheduler server ss.

In addition, assume that the reception unit 421 receives a state display request for the job including the job ID by the job state display command 433. In this case, the job state local administration unit 424 determines whether or not an execution request for the computation resource allocation process that targets the job is sent to the scheduler server ss. Assume that the job state local administration unit 424 determines that an execution request for the computation resource allocation process that targets the job is not sent to the scheduler server ss. In this case, the job state local administration unit 424 sends, as information indicating the state of the job, information indicating a computation resource not being allocated to the job to the user terminal ut that is the request source of the state display request. For example, the job state local administration unit 424 sends “job ID: xx waiting for computation resource allocation” to the user terminal ut. In the case of determining that an execution request for the allocation process that targets the job is previously sent to the scheduler server ss, the job state local administration unit 424 sends a state acquisition request for the job to the scheduler server ss.

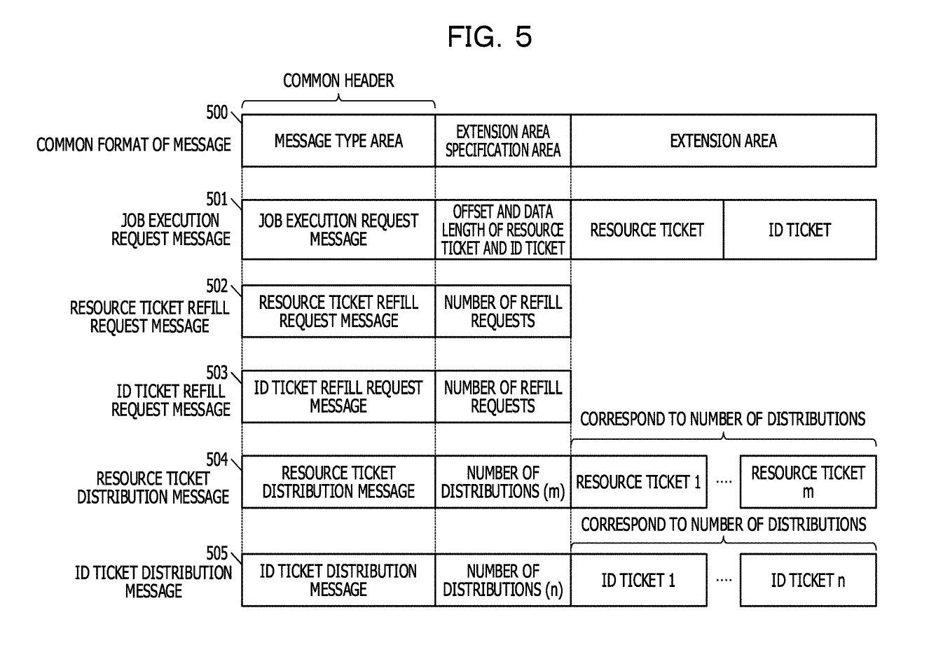

Next, one example of a message format used in the first example will be described with FIG. 5.

FIG. 5 illustrates one example of a message format. A common format 500 of a message illustrated in FIG. 5 represents a format that is common in message formats used in the first example. Examples of a message that follows the common format 500 include a job execution request message 501, a resource ticket refill request message 502, an ID ticket refill request message 503, a resource ticket distribution message 504, and an ID ticket distribution message 505.

The common format 500 includes fields of a message type area as a common header, an extension area specification area, and an extension area. The message type area field stores an identifier that indicates the type of message. The message type area field in the job execution request message 501 to the ID ticket distribution message 505 stores an identifier that indicates the type of each message. The extension area specification area field stores data that specifies a content stored in the extension area. The extension area field stores a field that is specified by the extension area specification area.

The job execution request message 501 is a message for an execution request for the computation resource allocation process that targets a job. The extension area specification area field of the job execution request message 501 stores offsets and data lengths of the resource ticket rtix and the ID ticket itix. In addition, the extension area of the job execution request message 501 stores the resource ticket rtix and the ID ticket itix. The resource ticket rtix includes a resource ticket ID. In addition, the resource ticket rtix may include extension information. Examples of the extension information of the resource ticket rtix include a time that represents the expiry of the resource ticket rtix. Similarly, the ID ticket itix includes the job ID. In addition, the ID ticket itix may include extension information. Examples of the extension information include a time that represents the expiry of the ID ticket itix.

The resource ticket refill request message 502 is a message for a request for a refill of the resource ticket rtix. The extension area specification area field of the resource ticket refill request message 502 stores the number of refill requests for the resource ticket rtix. Similarly, the ID ticket refill request message 503 is a message for a request for a refill of the ID ticket itix. The extension area specification area field of the ID ticket refill request message 503 stores the number of refill requests for the ID ticket itix.

The resource ticket distribution message 504 is a message for distribution of the resource ticket rtix. The extension area specification area field of the resource ticket distribution message 504 stores the number of distributions of resource tickets rtix. In the example in FIG. 5, the extension area specification area field of the resource ticket distribution message 504 stores a natural number m. The extension area of the resource ticket distribution message 504 stores the resource tickets rtix corresponding in number to the number of distributions. In the example in FIG. 5, the extension area of the resource ticket distribution message 504 stores m resource tickets rtix.

Similarly, the ID ticket distribution message 505 is a message for distribution of the ID ticket itix. The extension area specification area field of the ID ticket distribution message 505 stores the number of distributions of ID tickets itix. In the example in FIG. 5, the extension area specification area field of the ID ticket distribution message 505 stores a natural number n. The extension area of the ID ticket distribution message 505 stores the ID tickets itix corresponding in number to the number of distributions. In the example in FIG. 5, the extension area of the ID ticket distribution message 505 stores n ID tickets itix.

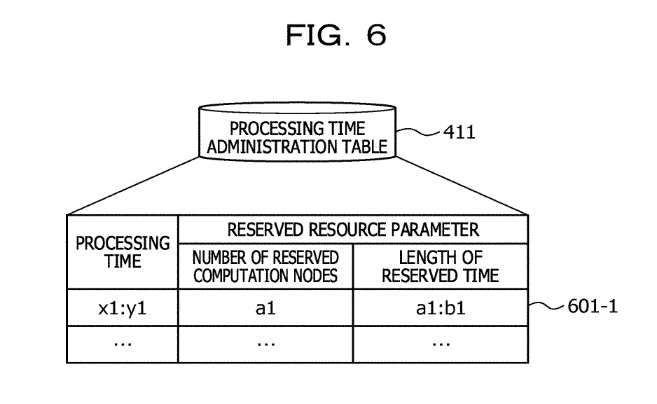

Next, examples of the processing time administration table 411 to the ID ticket refill table 415 will be respectively described by using FIG. 6 to FIG. 10.

FIG. 6 illustrates one example of a processing time administration table. The processing time administration table 411 illustrated in FIG. 6 has a record 601-1.

The processing time administration table 411 includes fields of processing time and a reserved resource parameter. The processing time field stores a value that indicates the amount of processing time taken for the computation resource allocation process. The reserved resource parameter field stores a value that indicates a reserved resource parameter specified by the user. For example, the reserved resource parameter field has sub-fields of the number of reserved computation nodes and the length of reserved time. The sub-field of the number of reserved computation nodes stores the number of computation nodes cn, specified by the user, executing jobs. The sub-field of the length of reserved time stores a value that indicates the length of time, specified by the user, until the end of execution of a job even if the job is not finished.

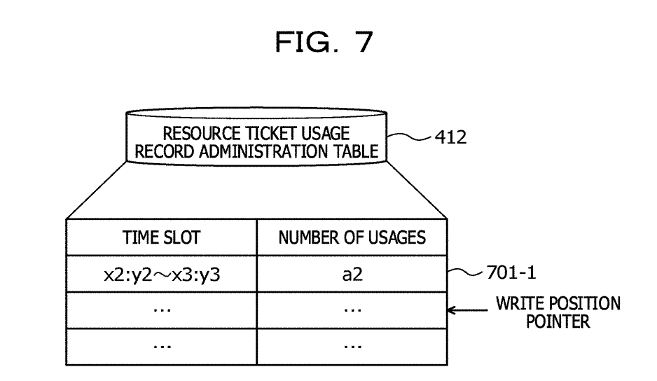

FIG. 7 illustrates one example of a resource ticket usage record administration table. The resource ticket usage record administration table 412 illustrated in FIG. 7 has a record 701-1. In addition, the resource ticket usage record administration table 412 is associated with a write position pointer.

The resource ticket usage record administration table 412 includes fields of a time slot and the number of usage. The time slot field stores a value that indicates a time slot. The number of usage field stores the number of usage of resource tickets rtix in the time slot indicated in the time slot field.

In addition, the write position pointer that is associated with the resource ticket usage record administration table 412 is a pointer that indicates the position of a record to be subsequently written into the resource ticket usage record administration table 412.

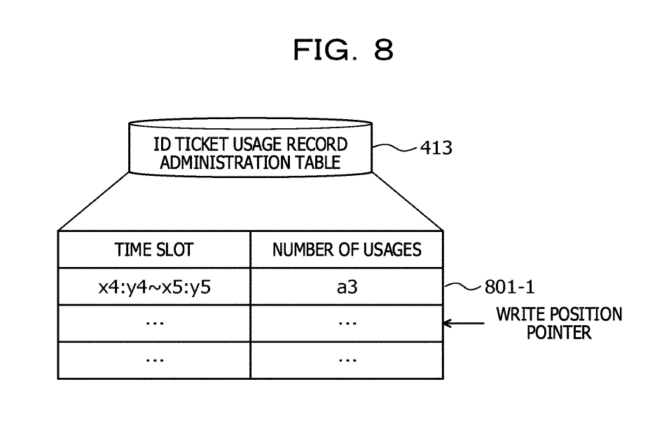

FIG. 8 illustrates one example of an ID ticket usage record administration table. The ID ticket usage record administration table 413 illustrated in FIG. 8 has a record 801-1. In addition, the ID ticket usage record administration table 413 is associated with a write position pointer.

The ID ticket usage record administration table 413 includes fields of a time slot and the number of usage. The time slot field stores a character string that indicates a time slot. The number of usage field stores the number of usage of ID tickets itix in the time slot indicated in the time slot field.

In addition, the write position pointer that is associated with the ID ticket usage record administration table 413 is a pointer that indicates the position of a record to be subsequently written into the ID ticket usage record administration table 413.

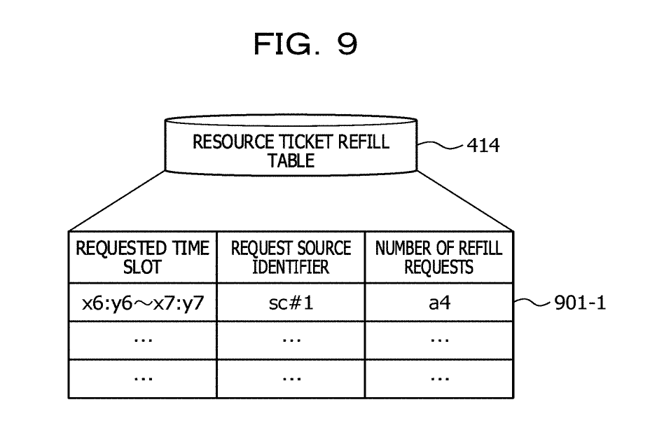

FIG. 9 illustrates one example of a resource ticket refill table. The resource ticket refill table 414 illustrated in FIG. 9 has a record 901-1.

The resource ticket refill table 414 includes fields of a requested time slot, a request source identifier, and the number of refill requests. The requested time slot field stores a character string that indicates a time slot including a time of a request for the resource ticket rtix. The request source identifier field stores an identifier that identifies the scheduler client sc requesting the resource ticket rtix. The number of refill requests field stores the number of resource tickets rtix requested by the scheduler client sc.

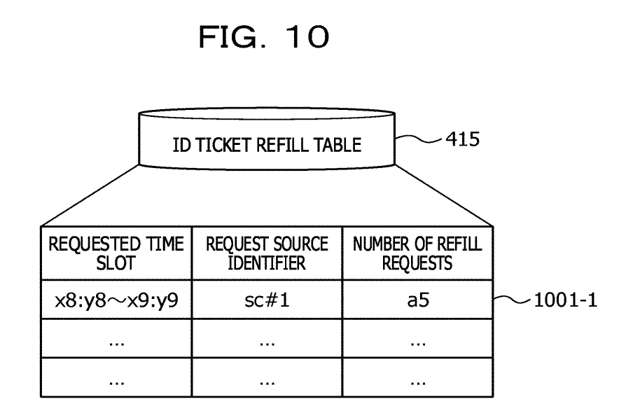

FIG. 10 illustrates one example of a stored content of an ID ticket refill table. The ID ticket refill table 415 illustrated in FIG. 10 has a record 1001-1.

The ID ticket refill table 415 includes fields of a requested time slot, a request source identifier, and the number of refill requests. The requested time slot field stores a character string that indicates a time slot including a time of a request for the ID ticket itix. The request source identifier field stores an identifier that identifies the scheduler client sc requesting the ID ticket itix. The number of refill requests field stores the number of ID tickets itix requested by the scheduler client sc.

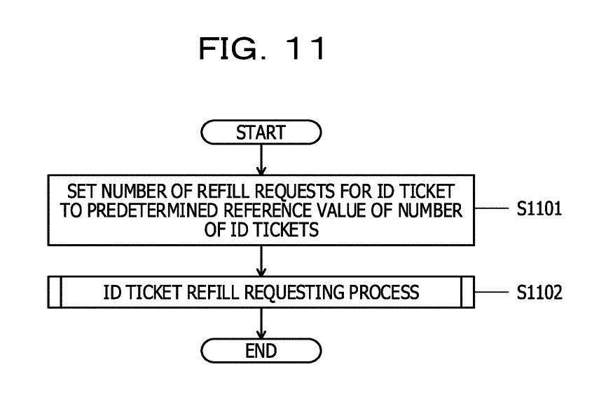

Next, a flowchart of execution by the scheduler client sc will be described by using FIG. 11 to FIG. 19.

FIG. 11 is a flowchart illustrating one example of an ID ticket initialization process procedure in a scheduler client. An ID ticket initialization process in the scheduler client sc is a process that is executed by the scheduler client sc when operation of the HPC system 200 is started.

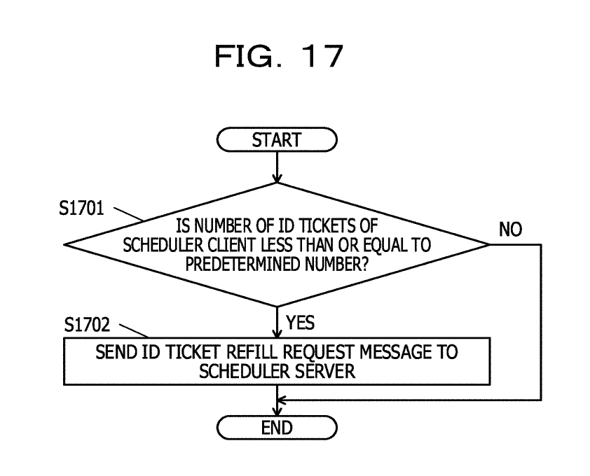

The scheduler client sc sets the number of refill requests for the ID ticket to a predetermined reference value of the number of ID tickets (Step S1101). Next, the scheduler client sc executes an ID ticket refill requesting process (Step S1102). The ID ticket refill requesting process is illustrated in FIG. 17. After the process of Step S1102 is finished, the scheduler client sc finishes the ID ticket initialization process.

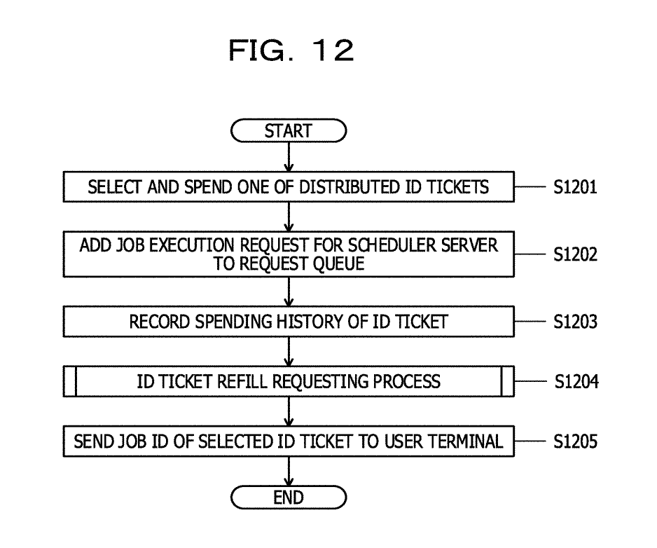

FIG. 12 is a flowchart illustrating one example of a job input process procedure in the scheduler client. A job input process in the scheduler client sc is a process that is executed by the scheduler client sc when a job is input from the user terminal ut by the job input command 431.

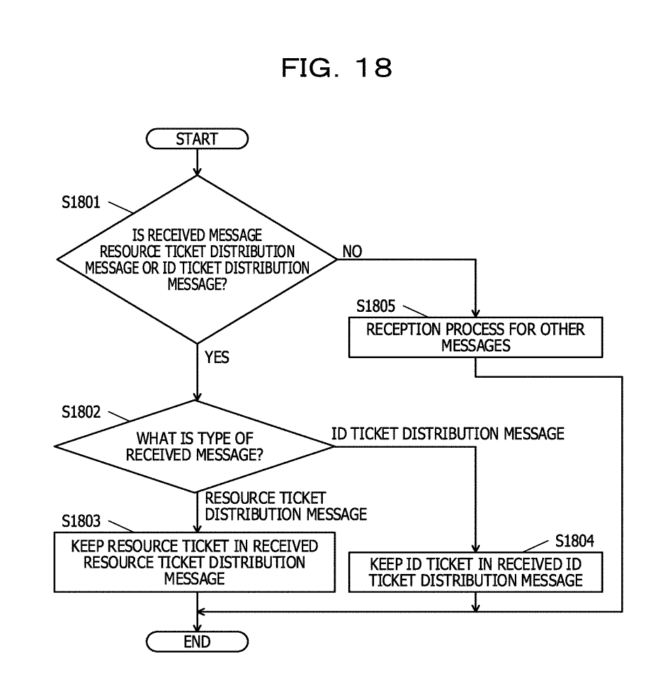

The scheduler client sc selects and spends one of the distributed ID tickets itix (Step S1201). The ID tickets itix are distributed from the scheduler server ss by a message reception process illustrated in FIG. 18 with the refill requesting process in Step S1102 as a trigger.

Next, the scheduler client sc adds a job execution request for the scheduler server ss to the request queue (Step S1202). The scheduler client sc records a spending history of the ID ticket itix (Step S1203). Next, the scheduler client sc executes the ID ticket refill requesting process (Step S1204). The scheduler client sc sends the job ID of the selected ID ticket itix to the user terminal ut (Step S1205). After the process of Step S1205 is finished, the scheduler client sc finishes the job input process.

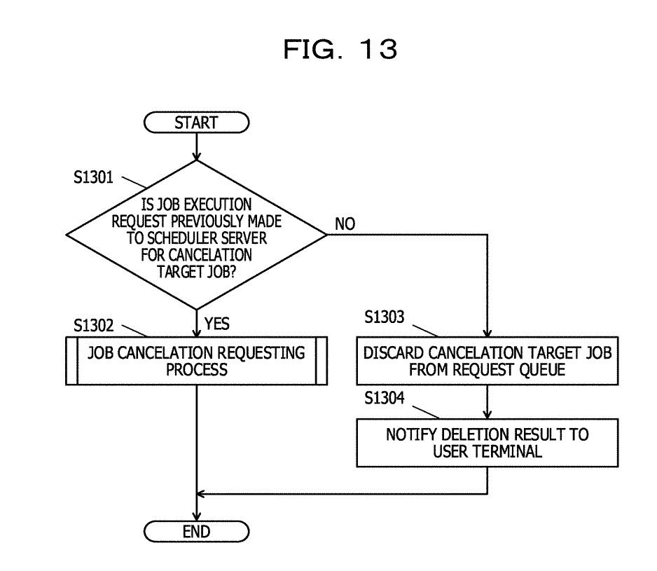

FIG. 13 is a flowchart illustrating one example of a job execution cancelation process procedure in the scheduler client. A job execution cancelation process in the scheduler client sc is a process that is executed in the case of reception of a job cancelation request from the user terminal ut. In addition, the scheduler client sc also receives the job ID of a cancelation target when receiving the job cancelation request from the user terminal ut.

The scheduler client sc determines whether or not a job execution request is previously made to the scheduler server ss for the job of the cancelation target (Step S1301). For example, a job for which a job execution request is previously made to the scheduler server ss is a job that is a target in a process of Step S1903 described later.

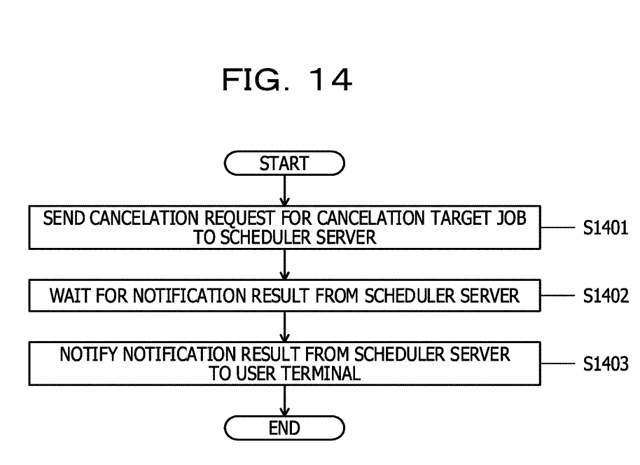

In the case of a job execution request being previously made to the scheduler server ss for the job of the cancelation target (Step S1301: Yes), the scheduler client sc executes a job cancelation requesting process (Step S1302). The job cancelation requesting process is illustrated in FIG. 14. Meanwhile, in the case of a job execution request not being previously made to the scheduler server ss (Step S1301: No), the scheduler client sc discards the job of the cancelation target from the request queue (Step S1303). The scheduler client sc notifies the deletion result to the user terminal ut that sends the job cancelation command 432 (Step S1304).

After the process of Step S1302 or Step S1304 is finished, the scheduler client sc finishes the job execution cancelation process.

FIG. 14 is a flowchart illustrating one example of a job cancelation requesting process procedure in the scheduler client. A job cancelation request in the scheduler client sc is a process of sending a job cancelation request to the scheduler server ss.

The scheduler client sc sends a job cancelation request for the cancelation target to the scheduler server ss (Step S1401). Next, the scheduler client sc waits for a notification result from the scheduler server ss (Step S1402). The scheduler client sc notifies the notification result from the scheduler server ss to the user terminal ut that sends the job cancelation command 432 (Step S1403). After the process of Step S1403 is finished, the scheduler client sc finishes the job cancelation requesting process.

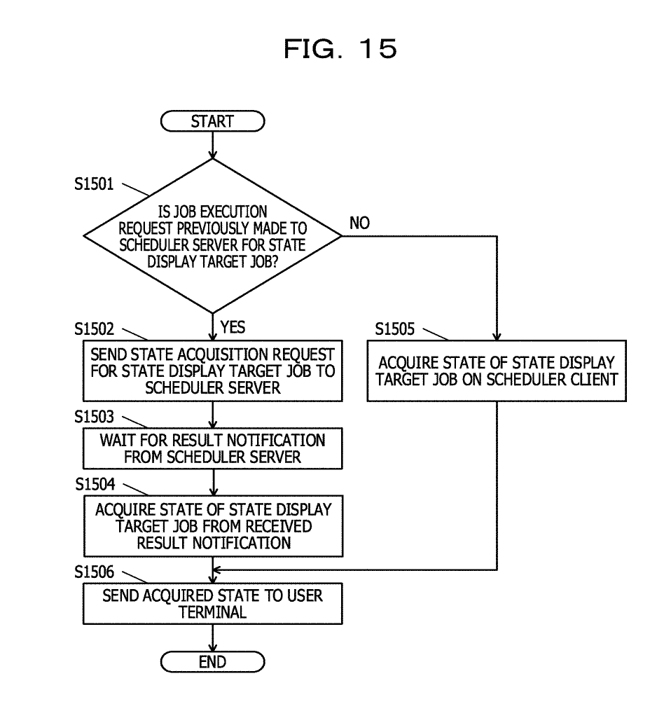

FIG. 15 is a flowchart illustrating one example of a job state display process procedure in the scheduler client. A job state display process in the scheduler client sc is a process that is executed in the case of reception of the job state display command 433 from the user terminal ut. In addition, the scheduler client sc also receives the job ID of a state display target when receiving the job state display command 433 from the user terminal ut.

The scheduler client sc determines whether or not a job execution request is previously made to the scheduler server ss for the job of the state display target (Step S1501). In the case of a job execution request being previously made to the scheduler server ss (Step S1501: Yes), the scheduler client sc sends a state acquisition request for the job of the state display target to the scheduler server ss (Step S1502). Next, the scheduler client sc waits for a result notification from the scheduler server ss (Step S1503). The scheduler client sc acquires the state of the job of the state display target from the received result notification (Step S1504).

Meanwhile, in the case of a job execution request not being previously made to the scheduler server ss (Step S1501: No), the scheduler client sc acquires the state of the job of the state display target on the scheduler client sc (Step S1505).

After the process of Step S1504 or Step S1505 is finished, the scheduler client sc sends the acquired state of the job of the state display target to the user terminal ut that sends the job state display command 433 (Step S1506). After the process of Step S1506 is finished, the scheduler client sc finishes the job state display process.

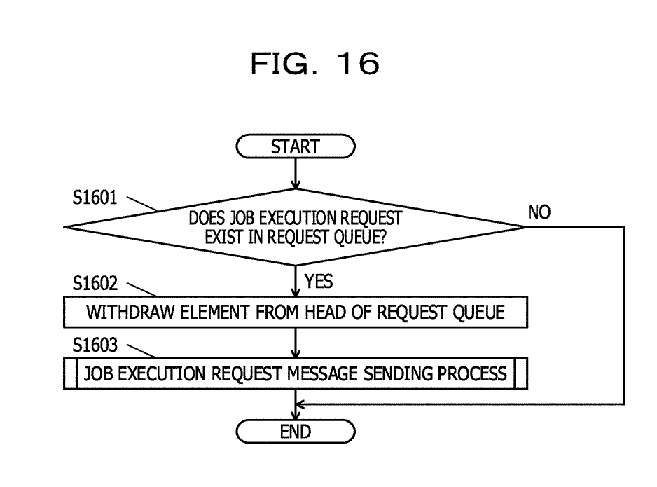

FIG. 16 is a flowchart illustrating one example of a job execution requesting process procedure in the scheduler client. A job execution requesting process in the scheduler client sc is a process of sending an execution request for the computation resource allocation process to the scheduler server ss. For example, an execution request for the computation resource allocation process is executed for each fixed amount of time or when a job execution request is stored in the request queue. A job execution request is added to the request queue as illustrated by Step S1202.

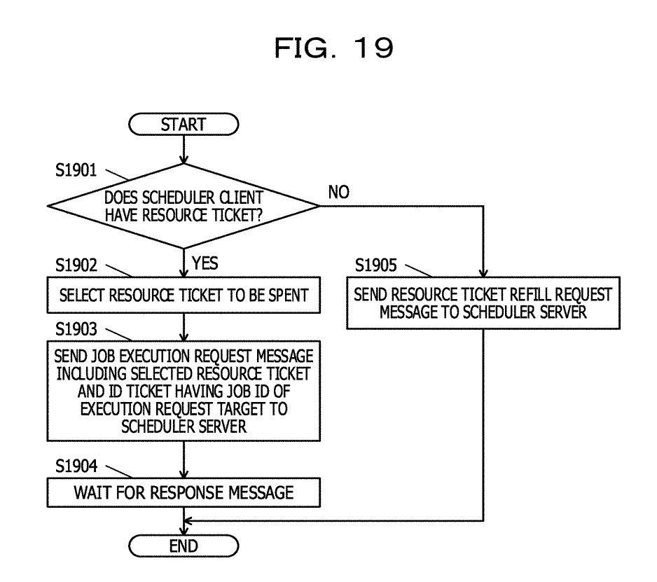

The scheduler client sc determines whether or not the request queue has a job execution request (Step S1601). In the case of the request queue having a job execution request (Step S1601: Yes), the scheduler client sc withdraws an element from the head of the request queue (Step S1602). The scheduler client sc executes a job execution request message sending process for the job ID of the withdrawn element (Step S1603). The job execution request message sending process is illustrated in FIG. 19.

After the process of Step S1603 is finished, or in the case of the request queue not having a job execution request (Step S1601: No), the scheduler client sc finishes the job execution requesting process.

FIG. 17 is a flowchart illustrating one example of an ID ticket refill requesting process procedure in the scheduler client. An ID ticket refill requesting process in the scheduler client sc is a process of requesting the scheduler server ss to perform a refill of the ID ticket itix.

The scheduler client sc determines whether or not the number of ID tickets of the scheduler client sc is less than or equal to a predetermined number (Step S1701). In the case of the number of ID tickets of the scheduler client sc being less than or equal to the predetermined number (Step S1701: Yes), the scheduler client sc sends the ID ticket refill request message 503 to the scheduler server ss (Step S1702).

After the process of Step S1702 is finished, or in the case of the number of ID tickets of the scheduler client sc being greater than the predetermined number (Step S1701: No), the scheduler client sc finishes the ID ticket refill requesting process.

FIG. 18 is a flowchart illustrating one example of a message reception process procedure in the scheduler client. A message reception process in the scheduler client sc is a process that is executed by the scheduler client sc when receiving a message.

The scheduler client sc determines whether the received message is the resource ticket distribution message 504 or the ID ticket distribution message 505 or not (Step S1801). In the case of the received message being the resource ticket distribution message 504 or the ID ticket distribution message 505 (Step S1801: Yes), the scheduler client sc confirms the type of received message (Step S1802). In the case of the type of received message being the resource ticket distribution message 504 (Step S1802: resource ticket distribution message), the scheduler client sc keeps the resource ticket rtix in the received resource ticket distribution message 504 (Step S1803). In addition, in the case of the type of received message being the ID ticket distribution message 505 (Step S1802: ID ticket distribution message), the scheduler client sc keeps the ID ticket itix in the received ID ticket distribution message 505 (Step S1804).

In addition, in the case of the received message not being any of the resource ticket distribution message 504 and the ID ticket distribution message 505 (Step S1801: No), the scheduler client sc executes a reception process for other messages (Step S1805).

After the process of any of Step S1803 to Step S1805 is finished, the scheduler client sc finishes the message reception process.

FIG. 19 is a flowchart illustrating one example of a job execution request message sending process procedure in the scheduler client. A job execution request message sending process in the scheduler client sc is a process of sending the job execution request message 501 to the scheduler server ss. In addition, the job execution request message sending process is assigned the job ID of an execution request target as a parameter.

The scheduler client sc determines whether or not the scheduler client sc has the resource ticket rtix (Step S1901). In the case of the scheduler client sc having the resource ticket rtix (Step S1901: Yes), the scheduler client sc selects the resource ticket rtix to be spent from the resource tickets rtix of the scheduler client sc (Step S1902). Next, the scheduler client sc sends, to the scheduler server ss, the job execution request message 501 that includes the selected resource ticket rtix and the ID ticket itix having the job ID of the execution request target received as a parameter (Step S1903). The scheduler client sc waits for a response message from the scheduler server ss (Step S1904).

Meanwhile, in the case of the scheduler client sc not having the resource ticket rtix (Step S1901: No), the scheduler client sc sends the resource ticket refill request message 502 to the scheduler server ss (Step S1905).

After the process of Step S1904 or Step S1905 is finished, the scheduler client sc finishes the job execution request message sending process.

In addition, in the process of Step S1904, the scheduler client sc adds the job withdrawn from the head of the request queue to the head of the request queue again. Accordingly, the scheduler client sc, in the case of not having the resource ticket rtix and not being capable of making an execution request for the computation resource allocation process, may send an execution request for the computation resource allocation process that targets the job, when acquiring the resource ticket rtix later. Alternatively, in the process of Step S1904, the scheduler client sc may wait until receiving the resource ticket distribution message 504.

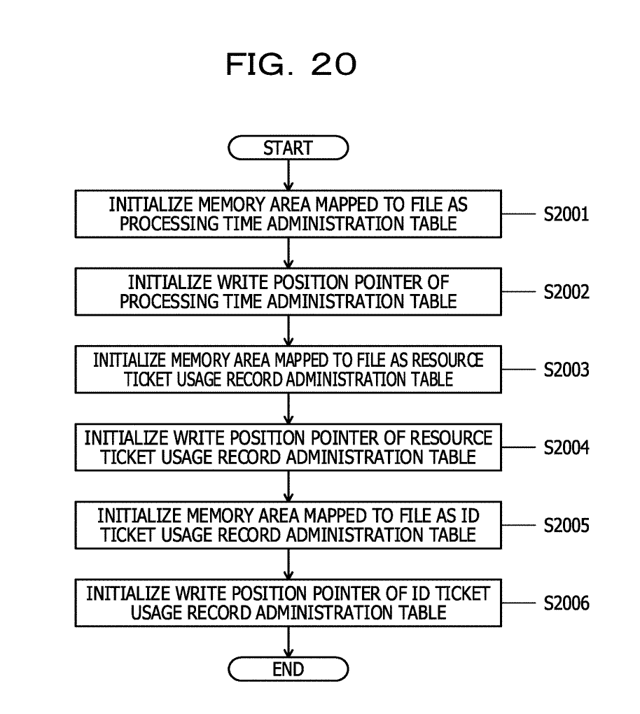

Next, a flowchart of execution by the scheduler server ss will be described by using FIG. 20 to FIG. 35.

FIG. 20 is a flowchart illustrating one example of an initialization process procedure in a scheduler server. An initialization process in the scheduler server ss is a process that is executed by the scheduler server ss when operation of the HPC system 200 is started.

The scheduler server ss initializes, as the processing time administration table 411, a memory area that is mapped to a file (Step S2001). Next, the scheduler server ss initializes a write position pointer of the processing time administration table 411 (Step S2002).

In addition, the scheduler server ss initializes, as the resource ticket usage record administration table 412, a memory area that is mapped to a file (Step S2003). Next, the scheduler server ss initializes the write position pointer of the resource ticket usage record administration table 412 (Step S2004).

In addition, the scheduler server ss initializes, as the ID ticket usage record administration table 413, a memory area that is mapped to a file (Step S2005). Next, the scheduler server ss initializes the write position pointer of the ID ticket usage record administration table 413 (Step S2006). After the process of Step S2006 is finished, the scheduler server ss finishes the initialization process.

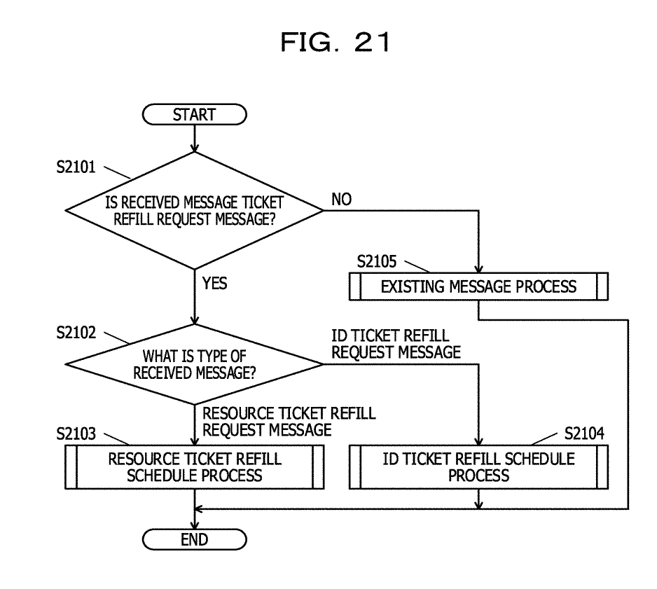

FIG. 21 is a flowchart illustrating one example of a request message process procedure in the scheduler server. A request message process in the scheduler server ss is a process that is executed by the computation resource allocation administration unit 401 of the scheduler server ss when receiving a message.

The computation resource allocation administration unit 401 determines whether or not the received message is a ticket refill request message (Step S2101). The ticket refill request message collectively refers to the resource ticket refill request message 502 and the ID ticket refill request message 503. In the case of a ticket refill request message (Step S2101: Yes), the computation resource allocation administration unit 401 confirms the type of received message (Step S2102).

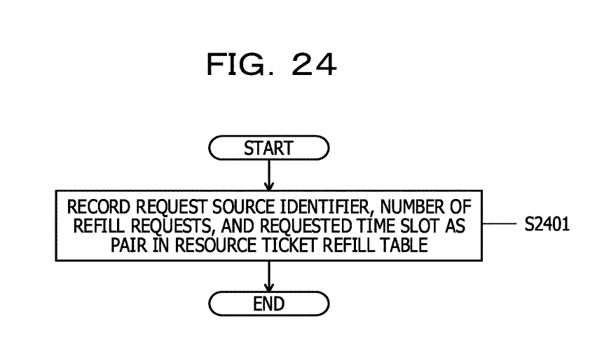

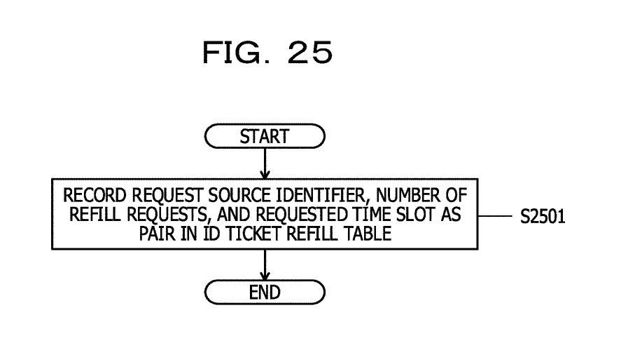

In the case of the type of received message being the resource ticket refill request message 502 (Step S2102: resource ticket refill request message), the computation resource allocation administration unit 401 executes a resource ticket refill schedule process (Step S2103). The resource ticket refill schedule process is illustrated in FIG. 24. In addition, in the case of the type of received message being the ID ticket refill request message 503 (Step S2102: ID ticket refill request message), the computation resource allocation administration unit 401 executes an ID ticket refill schedule process (Step S2104). The ID ticket refill schedule process is illustrated in FIG. 25.

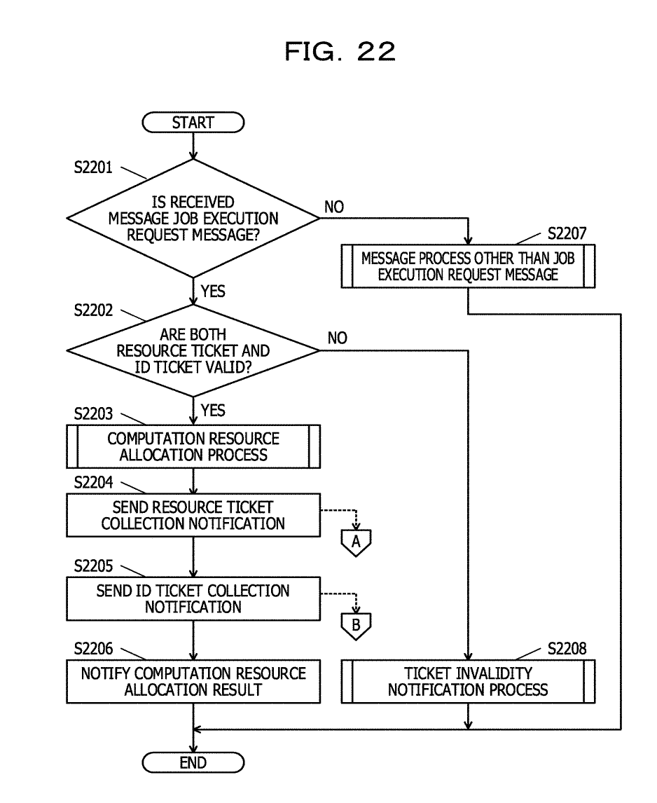

Meanwhile, in the case of the type of received message not being a ticket refill request message (Step S2101: No), the computation resource allocation administration unit 401 executes an existing message process (Step S2105). The existing message process is illustrated in FIG. 22. After the processes of Step S2103 to Step S2105 are finished, the computation resource allocation administration unit 401 finishes the request message process.

FIG. 22 is a flowchart illustrating one example of an existing message process procedure in the scheduler server. The existing message process in the scheduler server ss is a process that is executed by the computation resource allocation administration unit 401 of the scheduler server ss when receiving a message other than the resource ticket refill request message 502 and the ID ticket refill request message 503.

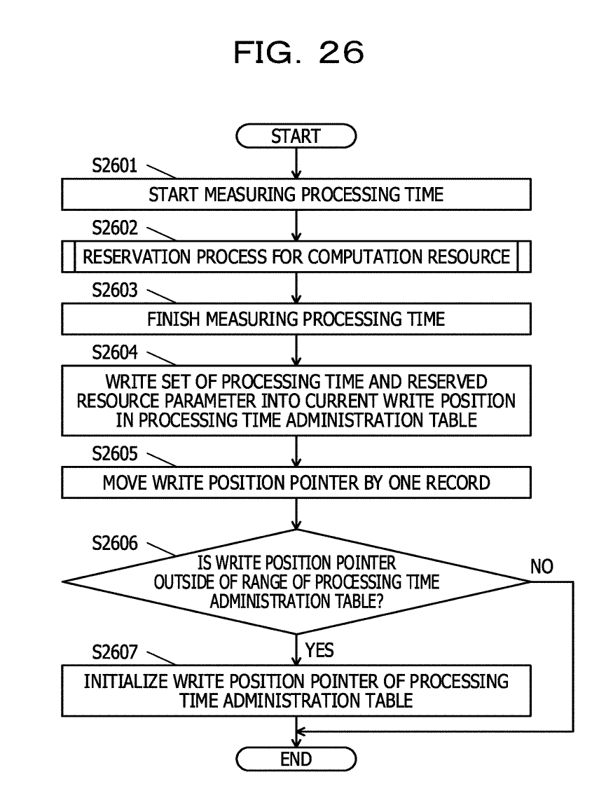

The computation resource allocation administration unit 401 determines whether or not the received message is the job execution request message 501 (Step S2201). In the case of the received message being the job execution request message 501 (Step S2201: Yes), the computation resource allocation administration unit 401 determines whether or not both of the resource ticket rtix and the ID ticket itix are valid (Step S2202). In the case of both of the resource ticket rtix and the ID ticket itix being valid (Step S2202: Yes), the computation resource allocation administration unit 401 executes the computation resource allocation process that targets the job of the received job execution request message 501 (Step S2203). The computation resource allocation process is illustrated in FIG. 26.

The computation resource allocation administration unit 401 sends the resource ticket collection notification to the ticket administration unit 402 (Step S2204). In addition, the computation resource allocation administration unit 401 sends the ID ticket collection notification to the ticket administration unit 402 (Step S2205). The computation resource allocation administration unit 401 notifies a computation resource allocation result to the scheduler client sc (Step S2206).

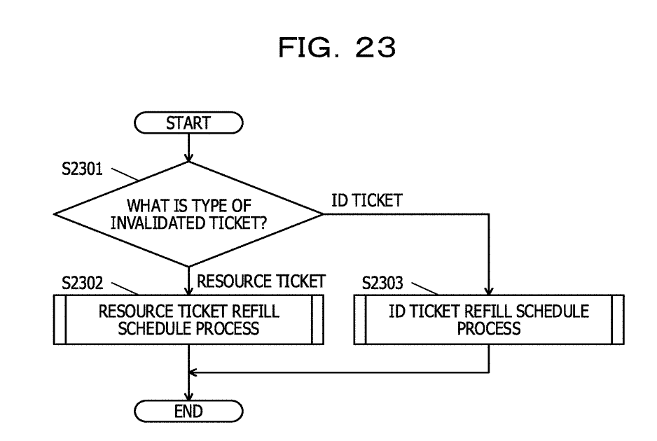

In the case of the received message not being the job execution request message 501 (Step S2201: No), the computation resource allocation administration unit 401 executes a message process other than the job execution request message (Step S2207). In addition, in the case of at least any one of the resource ticket rtix and the ID ticket itix being invalid (Step S2202: No), the computation resource allocation administration unit 401 executes a ticket invalidity notification process (Step S2208). The ticket invalidity notification process will be described with FIG. 23.

After the process of any of Steps S2206 to S2208 is finished, the computation resource allocation administration unit 401 finishes the existing message process.

FIG. 23 is a flowchart illustrating one example of a ticket invalidity notification process procedure in the scheduler server. The ticket invalidity notification process in the scheduler server ss is a process for an invalidated ticket.

The computation resource allocation administration unit 401 confirms the type of invalidated ticket (Step S2301). In the case of the type of invalidated ticket being the resource ticket rtix (Step S2301: resource ticket), the computation resource allocation administration unit 401 executes the resource ticket refill schedule process (Step S2302). In addition, in the case of the type of invalidated ticket being the ID ticket itix (Step S2301: ID ticket), the computation resource allocation administration unit 401 executes the ID ticket refill schedule process (Step S2303).

After the process of Step S2302 or Step S2303 is finished, the computation resource allocation administration unit 401 finishes the ticket invalidity notification process.

FIG. 24 is a flowchart illustrating one example of a resource ticket refill schedule process procedure in the scheduler server. The resource ticket refill schedule process in the scheduler server ss is a process of updating the resource ticket refill table 414. In addition, the resource ticket refill schedule process is a process that is executed by the ticket administration unit 402.

The ticket administration unit 402 records the request source identifier, the number of refill requests, and the requested time slot as a pair in the resource ticket refill table 414 (Step S2401). The resource ticket refill schedule process is called from the process of Step S2103 or the process of Step S2302. In the case of a call from the process of Step S2103, the ticket administration unit 402 stores the contents of each field of the ID ticket refill request message 503 in the fields having the same name as each field in the resource ticket refill table 414.

In addition, in the case of a call from the process of Step S2302, the ticket administration unit 402 stores, in the request source identifier field of the resource ticket refill table 414, the identifier of the scheduler client sc that is the source of sending of the invalidated resource ticket rtix. In addition, the ticket administration unit 402 stores the number of invalidated resource tickets rtix in the number of refill requests field of the resource ticket refill table 414. In addition, the ticket administration unit 402 stores, in the number of refill requests field of the resource ticket refill table 414, the time slot of the job that is sent along with the invalidated resource ticket rtix.

After the process of Step S2401 is finished, the ticket administration unit 402 finishes the resource ticket refill schedule process.

FIG. 25 is a flowchart illustrating one example of an ID ticket refill schedule process procedure in the scheduler server. The ID ticket refill schedule process in the scheduler server ss is a process of updating the ID ticket refill table 415. In addition, the ID ticket refill schedule process is a process that is executed by the ticket administration unit 402.

The ticket administration unit 402 records the request source identifier, the number of refill requests, and the requested time slot as a pair in the ID ticket refill table 415 (Step S2501). The ID ticket refill schedule process is called from the process of Step S2104 or the process of Step S2303. Information stored in the ID ticket refill table 415 in each process is the same as that in the resource ticket refill schedule process and thus will not be described. After the process of Step S2501 is finished, the ticket administration unit 402 finishes the ID ticket refill schedule process.

FIG. 26 is a flowchart illustrating one example of a computation resource allocation process procedure in the scheduler server. The computation resource allocation process in the scheduler server ss is a process of allocating a computation resource to a job and also measuring and recording the amount of time taken for a reservation process for the computation resource. In addition, the computation resource allocation process is a process that is performed by cooperation between the computation resource allocation administration unit 401 and the ticket administration unit 402.

The computation resource allocation administration unit 401 starts measuring the amount of processing time (Step S2601). Next, the computation resource allocation administration unit 401 executes a reservation process for a computation resource (Step S2602). The computation resource allocation administration unit 401 finishes measuring the amount of processing time (Step S2603).

The computation resource allocation administration unit 401 notifies the measured amount of processing time to the ticket administration unit 402, and the ticket administration unit 402 writes a set of the amount of processing time and the reserved resource parameter into a current write position in the processing time administration table 411 (Step S2604). Next, the ticket administration unit 402 moves the write position pointer by one record (Step S2605). The ticket administration unit 402 determines whether or not the write position pointer is outside of the range of the processing time administration table 411 (Step S2606). In the case of the write position pointer being outside of the range of the processing time administration table 411 (Step S2606: Yes), the ticket administration unit 402 initializes the write position pointer of the processing time administration table 411 (Step S2607).

After the process of Step S2607 is finished, or in the case of the write position pointer not being outside of the range of the processing time administration table 411 (Step S2606: No), the ticket administration unit 402 finishes the computation resource allocation process.

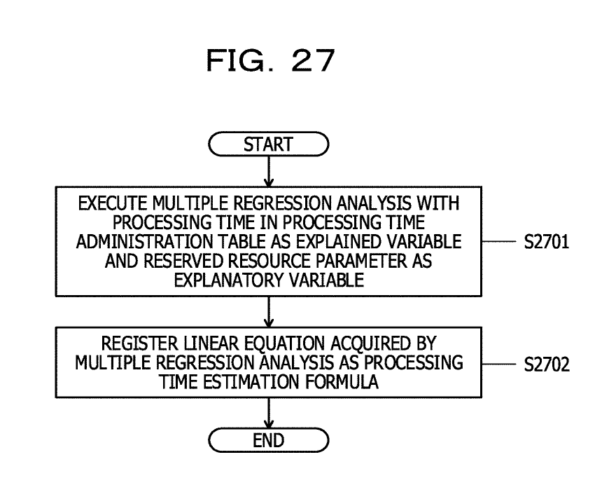

FIG. 27 is a flowchart illustrating one example of a processing time estimation formula recording process procedure in the scheduler server. A processing time estimation formula recording process in the scheduler server ss is a process of recording an estimation formula that estimates the amount of processing time of a reservation process for a computation resource. For example, the processing time estimation formula recording process is executed for each certain amount of time. In addition, the processing time estimation formula recording process is a process that is executed by the ticket administration unit 402.

The ticket administration unit 402 executes multiple regression analysis with the amount of processing time in the processing time administration table 411 as an explained variable and the reserved resource parameter as an explanatory variable (Step S2701). Next, the ticket administration unit 402 registers a linear equation acquired by multiple regression analysis as the processing time estimation formula (Step S2702). After the process of Step S2702 is finished, the ticket administration unit 402 finishes the processing time estimation formula recording process.

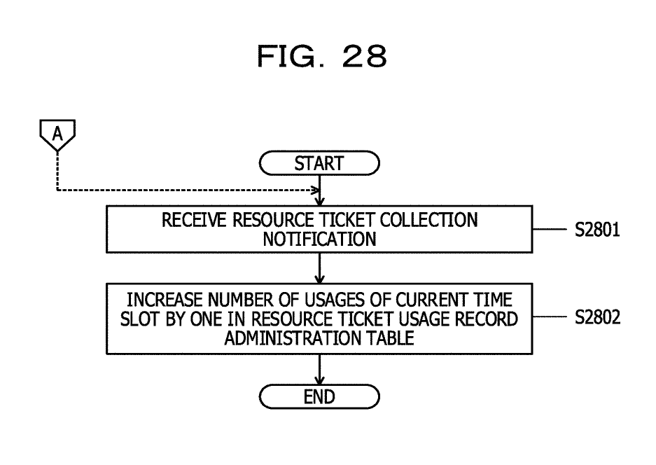

FIG. 28 is a flowchart illustrating one example of a resource ticket usage record recording process procedure in the scheduler server. A resource ticket usage record recording process in the scheduler server ss is a process that is executed in the case of reception of the resource ticket collection notification from the computation resource allocation administration unit 401. In addition, the resource ticket usage record recording process is a process that is executed by the ticket administration unit 402.

The ticket administration unit 402 receives the resource ticket collection notification (Step S2801). Next, the ticket administration unit 402 increases the number of usages of the current time slot by one in the resource ticket usage record administration table 412 (Step S2802). After the process of Step S2802 is finished, the ticket administration unit 402 finishes the resource ticket usage record recording process.

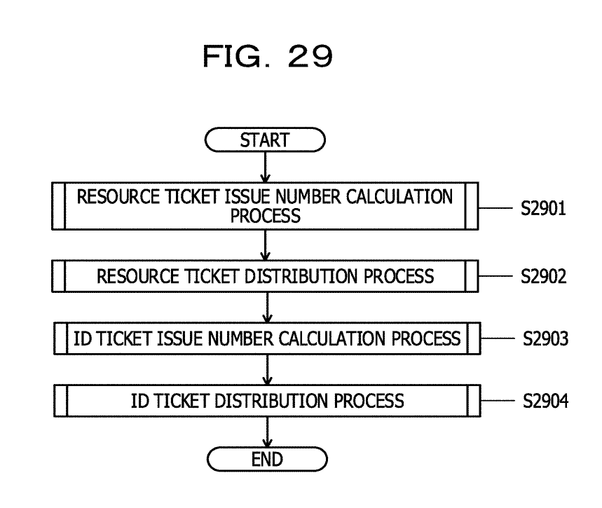

FIG. 29 is a flowchart illustrating one example of a ticket administration process procedure in the scheduler server. A ticket administration process in the scheduler server ss is a process of administering the resource ticket rtix and the ID ticket itix. The ticket administration process is operated for each certain amount of time. In addition, the ticket administration process is a process that is executed by the ticket administration unit 402.

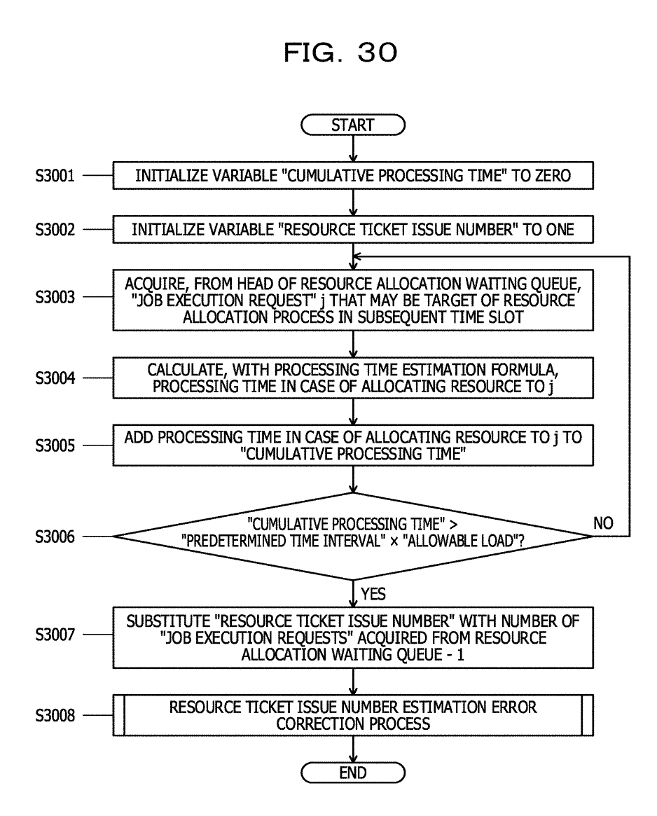

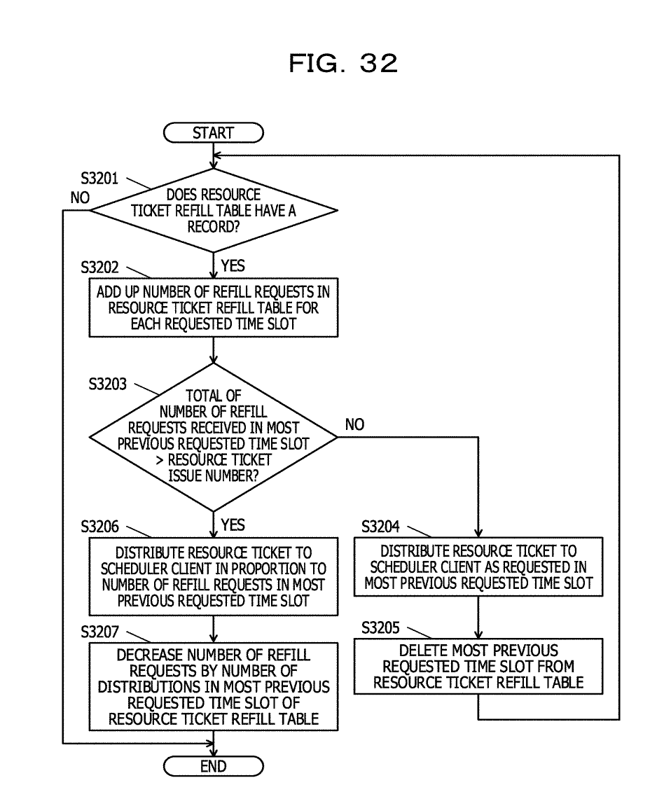

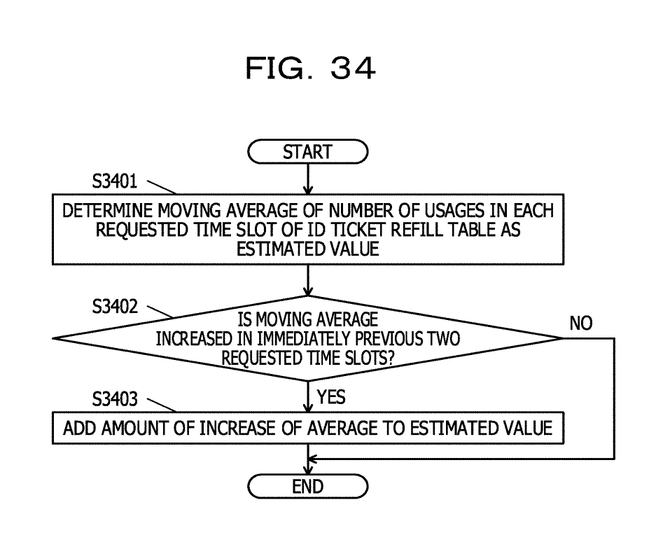

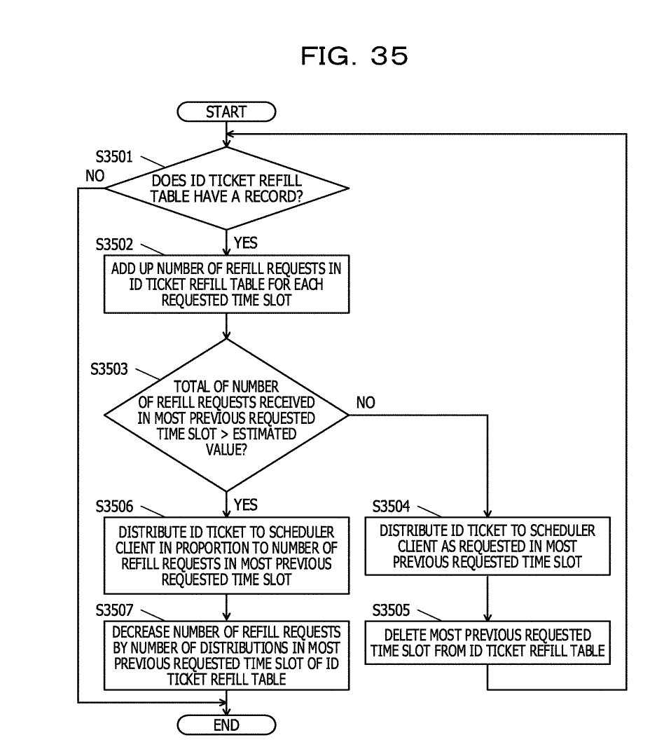

The ticket administration unit 402 executes a resource ticket issue number calculation process (Step S2901). The resource ticket issue number calculation process is illustrated in FIG. 30. Next, the ticket administration unit 402 executes a resource ticket distribution process (Step S2902). The resource ticket distribution process is illustrated in FIG. 32. In addition, the ticket administration unit 402 executes an ID ticket issue number calculation process (Step S2903). The ID ticket issue number calculation process is illustrated in FIG. 34. Next, the ticket administration unit 402 executes an ID ticket distribution process (Step S2904). The ID ticket distribution process is illustrated in FIG. 35. After the process of Step S2904 is finished, the ticket administration unit 402 finishes the ticket administration process.

FIG. 30 is a flowchart illustrating one example of a resource ticket issue number calculation process procedure in the scheduler server. The resource ticket issue number calculation process in the scheduler server ss is a process of calculating the number of issuable resource tickets rtix. The resource ticket issue number calculation process is a process that is executed by the ticket administration unit 402.

The ticket administration unit 402 initializes a variable “cumulative processing time” to zero (Step S3001). Next, the ticket administration unit 402 initializes a variable “resource ticket issue number” to one (Step S3002). The ticket administration unit 402 acquires, from the head of a resource allocation waiting queue, a “job execution request” j that may be a resource allocation processing target in a subsequent time slot (Step S3003). Next, the ticket administration unit 402 calculates, with the processing time estimation formula, the amount of processing time in the case of resource allocation to j (Step S3004). The processing time estimation formula is acquired by the processing time estimation formula recording process illustrated in FIG. 27. In addition, the ticket administration unit 402 may execute the processing time estimation formula recording process illustrated in FIG. 27 when initially executing the process of Step S3004 after the resource ticket issue number calculation process is started.

Next, the ticket administration unit 402 adds the amount of processing time in the case of resource allocation to j to the “cumulative processing time” (Step S3005). The ticket administration unit 402 determines whether or not “cumulative processing time”>“predetermined time interval”×“allowable load” is established (Step S3006). The allowable load is a value determined in advance by the administrator of the HPC system 200 and is a constant greater than zero and less than one.

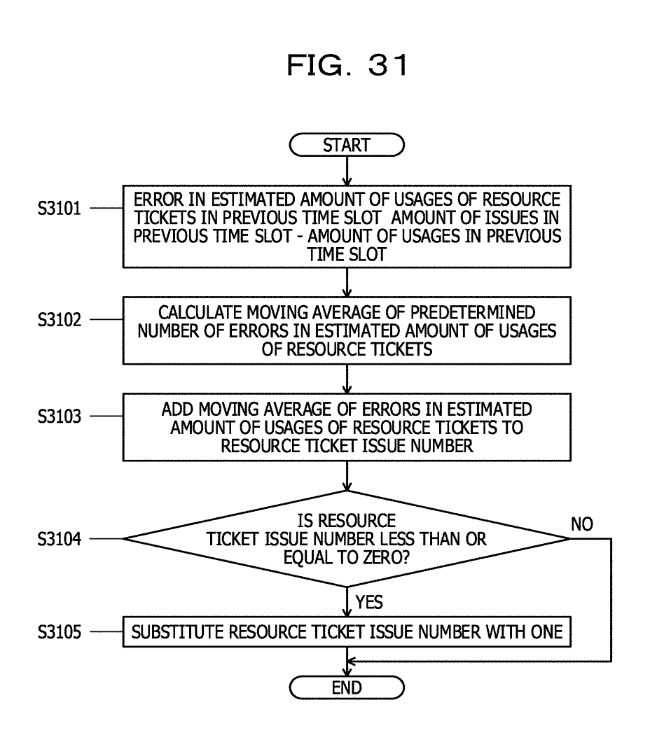

In the case of “cumulative processing time”≦“predetermined time interval”×“allowable load” (Step S3006: No), the ticket administration unit 402 transitions to the process of Step S3003. Meanwhile, in the case of “cumulative processing time”>“predetermined time interval”×“allowable load” (Step S3006: Yes), the ticket administration unit 402 substitutes the “resource ticket issue number” with the number of “job execution requests” acquired from the resource allocation waiting queue-1 (Step S3007). The ticket administration unit 402 executes a resource ticket issue number estimation error correction process (Step S3008). The resource ticket issue number estimation error correction process is illustrated in FIG. 31. After the process of Step S3008 is finished, the ticket administration unit 402 finishes the resource ticket issue number calculation process.

FIG. 31 is a flowchart illustrating one example of a resource ticket issue number estimation error correction process procedure in the scheduler server. The resource ticket issue number estimation error correction process in the scheduler server ss is a process of correcting error in the resource ticket issue number acquired by the process of Step S3007 in FIG. 30. The resource ticket issue number estimation error correction process is a process that is executed by the ticket administration unit 402.

The ticket administration unit 402 substitutes an error in the estimated amount of usages of resource tickets in a previous time slot with a calculation result of the amount of issues in the previous time slot—the amount of usages in the previous time slot (Step S3101). Next, the ticket administration unit 402 calculates the moving average of a predetermined number of errors in the estimated amount of usages of resource tickets (Step S3102). The ticket administration unit 402 adds the moving average of the errors in the estimated amount of usages of resource tickets to the resource ticket issue number (Step S3103).

Next, the ticket administration unit 402 determines whether or not the resource ticket issue number is less than or equal to zero (Step S3104). In the case of the resource ticket issue number being less than or equal to zero (Step S3104: Yes), the ticket administration unit 402 substitutes the resource ticket issue number with one (Step S3105).

After the process of Step S3105 is finished, or in the case of the resource ticket issue number being greater than zero (Step S3104: No), the ticket administration unit 402 finishes the resource ticket issue number estimation error correction process.

FIG. 32 is a flowchart illustrating one example of a resource ticket distribution process procedure in the scheduler server. The resource ticket distribution process in the scheduler server ss is a process of distributing the resource ticket rtix to the scheduler client sc based on the resource ticket issue number acquired by the resource ticket issue number estimation error correction process. The resource ticket distribution process is a process that is executed by the ticket administration unit 402.

The ticket administration unit 402 determines whether or not the resource ticket refill table 414 has a record (Step S3201). In the case of the resource ticket refill table 414 having a record (Step S3201: Yes), the ticket administration unit 402 adds up the number of refill requests in the resource ticket refill table 414 for each requested time slot (Step S3202).

One example of Step S3202 will be described. For example, assume that records 1 to 4 as below are registered in the resource ticket refill table 414.

Requested time slot: “x1:y1 to x2:y2”, request source identifier: “sc#1”, number of refill requests “2” . . . record 1

Requested time slot: “x1:y1 to x2:y2”, request source identifier: “sc#2”, number of refill requests “4” . . . record 2

Requested time slot: “x2:y2 to x3:y3”, request source identifier: “sc#1”, number of refill requests “3” . . . record 3

Requested time slot: “x2:y2 to x3:y3”, request source identifier: “sc#2”, number of refill requests “4” . . . record 4

“x1:y1 to x2:y2” is one time slot before “x2:y2 to x3:y3”. In the above example, the ticket administration unit 402 calculates the total of the number of refill requests for each requested time slot, that is, the total of the number of refill requests in “x1:y1 to x2:y2” and the total of the number of refill requests in “x2:y2 to x3:y3”. In this case, the ticket administration unit 402 calculates a total six of the number of refill requests in “x1:y1 to x2:y2” and a total seven of the number of refill requests in “x2:y2 to x3:y3”.

Next, the ticket administration unit 402 determines whether or not the total of the number of refill requests received in the most previous requested time slot is greater than the resource ticket issue number (Step S3203). If the above example is used, the most previous requested time slot is “x1:y1 to x2:y2”, and the total of the number of request refills received in “x1:y1 to x2:y2” is six.

In the case of the total of the number of refill requests received in the most previous requested time slot being less than or equal to the resource ticket issue number (Step S3203: No), the ticket administration unit 402 distributes the resource ticket rtix to the scheduler client sc as requested in the most previous requested time slot (Step S3204). In the above example, the ticket administration unit 402 distributes two resource tickets rtix to the scheduler client sc#1 and distributes four resource tickets rtix to the scheduler client sc#2. The ticket administration unit 402 deletes the most previous requested time slot from the resource ticket refill table 414 (Step S3205). The ticket administration unit 402 transitions to the process of Step S3201.

Meanwhile, in the case of the total of the number of refill requests received in the most previous requested time slot being greater than the resource ticket issue number (Step S3203: Yes), the ticket administration unit 402 distributes the resource ticket rtix to the scheduler client sc in proportion to the number of refill requests in the most previous requested time slot (Step S3206). In the above example, assume that the resource ticket issue number is three. In this case, the ticket administration unit 402 distributes 3×(2/(2+4))=1 resource ticket rtix to the scheduler client sc#1 and distributes 3×(4/(2+4))=2 resource tickets rtix to the scheduler client sc#2. The ticket administration unit 402 decreases the number of refill requests by the number of distributions in the most previous requested time slot of the resource ticket refill table 414 (Step S3207).

After the process of Step S3207 is finished, or in the case of the resource ticket refill table 414 not having a record (Step S3201: No), the ticket administration unit 402 finishes the resource ticket distribution process.

The ticket administration unit 402 distributes the resource ticket rtix to the scheduler client sc by using the resource ticket distribution message 504. While the ticket administration unit 402 may distribute the resource ticket rtix at each execution of the process of Step S3204, it is preferable to distribute the resource tickets rtix in a batched manner as a timing of distributing the resource ticket rtix. For example, the ticket administration unit 402 adds up the number of distributions of resource tickets rtix acquired by the process of Step S3204 for each scheduler client sc at each execution of the process of Step S3204.

After the process of Step S3201 is finished, the ticket administration unit 402 sends the resource ticket distribution message 504 having the total acquired by addition as the number of distributions to each scheduler client sc. Alternatively, after the process of Step S3207 is finished, the ticket administration unit 402 adds up the number of distributions of resource tickets rtix acquired by the process of Step S3204 for each scheduler client sc. The ticket administration unit 402 sends the resource ticket distribution message 504 having the total acquired by addition as the number of distributions to each scheduler client sc. Accordingly, the ticket administration unit 402 may distribute, to the scheduler client sc, the resource tickets rtix corresponding in number to the number of batched requests in each requested time slot.

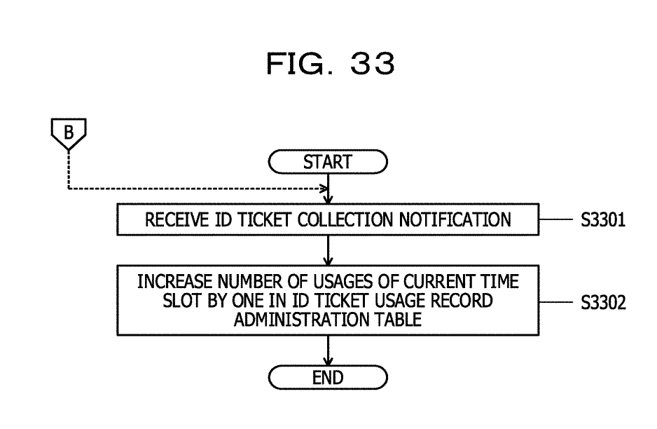

FIG. 33 is a flowchart illustrating one example of an ID ticket usage record recording process procedure in the scheduler server. An ID ticket usage record recording process in the scheduler server ss is a process that is executed in the case of reception of the ID ticket collection notification from the computation resource allocation administration unit 401. In addition, the ID ticket usage record recording process is a process that is executed by the ticket administration unit 402.

The ticket administration unit 402 receives the ID ticket collection notification (Step S3301). Next, the ticket administration unit 402 increases the number of usages of the current time slot by one in the ID ticket usage record administration table 413 (Step S3302). After the process of Step S3302 is finished, the ticket administration unit 402 finishes the ID ticket usage record recording process.

FIG. 34 is a flowchart illustrating one example of an ID ticket issue number calculation process procedure in the scheduler server. The ID ticket issue number calculation process in the scheduler server ss is a process of estimating the number of issues of ID tickets itix. In addition, the ID ticket issue number calculation process is a process that is executed by the ticket administration unit 402.

The ticket administration unit 402 determines the moving average of the number of usages in each requested time slot of the ID ticket refill table 415 as an estimated value (Step S3401). Next, the ticket administration unit 402 determines whether or not the moving average is increased in immediately previous two requested time slots (Step S3402). In the case of the moving average being increased in the immediately previous two requested time slots (Step S3402: Yes), the ticket administration unit 402 adds the amount of increase of the average to the estimated value (Step S3403).

After the process of Step S3403 is finished, or in the case of the moving average not being increased in the immediately previous two requested time slots (Step S3402: No), the ticket administration unit 402 finishes the ID ticket issue number calculation process.

FIG. 35 is a flowchart illustrating one example of an ID ticket distribution process procedure in the scheduler server. The ID ticket distribution process in the scheduler server ss is a process of distributing the ID ticket itix to the scheduler client sc based on the estimated value acquired by the ID ticket issue number calculation process. The ID ticket distribution process is a process that is executed by the ticket administration unit 402.

Steps S3501 to S3507 illustrated in FIG. 35 are the same as S3201 to S3207 illustrated in FIG. 32 except for “resource ticket issue number” replaced with “estimated value” and “resource” replaced with “ID” and thus will not be described. In addition, the ticket administration unit 402 distributes the ID ticket itix to the scheduler client sc by using the ID ticket distribution message 505.

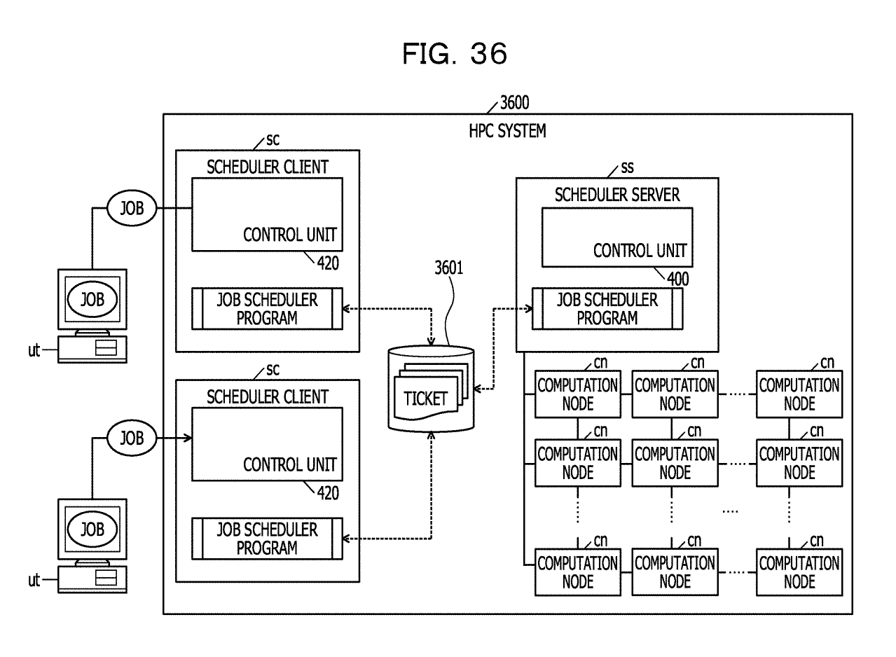

FIG. 36 illustrates a configuration example of an HPC system in a second example. An HPC system 3600 illustrated in FIG. 36 is realized by a database 3601 on a distributed file system. For example, reading the job scheduler program stored in the database 3601 realizes the control unit 400 in the scheduler server ss and the control unit 420 in the scheduler client sc. In the second example, ticket-related processes are performed by a database reference/update process in the job scheduler program without changing the original message format of the job scheduler system. Therefore, independence is increased in the second example between the ticket administration unit 402 of the scheduler server ss and another existing part.

In addition, each scheduler client sc may use the database 3601 to share the resource ticket rtix and the ID ticket itix distributed from the scheduler server ss.

As described heretofore, the scheduler server ss distributes the resource ticket rtix in advance to the scheduler client sc. The scheduler client sc spends the distributed resource ticket to request the scheduler server ss to perform the computation resource allocation process that targets the received job. Accordingly, the HPC system 200 may reduce load exerted on the scheduler server ss to a certain extent and may reduce the number of job inputs executed by the user reaching an upper limit.

In addition, the scheduler server ss may distribute the ID ticket itix in advance to the scheduler client sc. Accordingly, the scheduler client sc, even in a time slot of high load on the scheduler server ss, may send, to the user terminal ut, the job ID that is unique in the entire HPC system 200 and has a name space one-dimensionally administered on the scheduler server ss.

In addition, if the scheduler client sc, in the case of receiving the job cancelation command 432, does not yet send an execution request for the computation resource allocation process of the job specified by the job cancelation command 432 to the scheduler server ss, the scheduler client sc may discard the execution request. Accordingly, the scheduler client sc, in the case of not yet sending the execution request to the scheduler server ss, may cancel the execution request without exerting load on the scheduler server ss. Accordingly, even if a large number of job inputs are generated due to script error or trial and error of the user, the scheduler client sc may cancel the job inputs by the processes thereof before the job execution request message 501 is sent to the scheduler server ss.

In addition, the scheduler client sc, in the case of receiving the job state display command 433, determines whether or not an execution request for the computation resource allocation process of the job specified by the job state display command 433 is sent to the scheduler server ss. The scheduler client sc, if determining that the execution request is not yet sent to the scheduler server ss, may send information indicating a computation resource not being allocated to the job to the user terminal ut. Accordingly, the scheduler client sc, in the case of not yet sending the execution request to the scheduler server ss, may process the job state display command 433 without exerting load on the scheduler server ss.

In addition, the scheduler server ss stores the number of nodes executing each job at the time of performing the computation resource allocation process, the time slot of execution of each job, and the amount of time taken for the computation resource allocation process that targets each job. Next, the scheduler server ss may determine the number of jobs subjectable to the allocation process in a subsequent unit time from the stored number of nodes, the time slot, and the amount of time taken for the computation resource allocation process and from the number of nodes and the time slot for execution of jobs subjected to the computation resource allocation process in the subsequent unit time. Accordingly, the scheduler server ss may accurately estimate the number of jobs subjectable to the computation resource allocation process in the subsequent unit time.

In addition, each scheduler client sc may share the resource ticket rtix and the ID ticket itix distributed from the scheduler server ss. For example, the scheduler client sc may send the surplus resource ticket rtix to another scheduler client sc. The surplus resource ticket rtix indicates that the scheduler server ss has a surplus computation resource. Therefore, the scheduler client sc may effectively use the computation resource of the scheduler server ss by sending the surplus resource ticket rtix to another scheduler client sc.

In addition, the scheduler server ss performs communication by batching the resource tickets rtix in processing of a plurality of job inputs and not for each job input. Therefore, if the scheduler server ss has a large proportion of load due to a communication process with the scheduler client sc, communication load on the scheduler server ss may be decreased by increasing a communication interval and batching a large amount of data to improve an effective bandwidth.

In addition, the HPC system 200 may avoid a significant rise of load on the scheduler server ss at all times without an action of the user according to two reasons below. The first reason is that the number of job execution request messages 501 is restricted by the resource ticket rtix of which the amount of supply is restricted by the time slot. The second reason is that the job execution request message 501 or the resource ticket refill request message 502 is not sent by the user terminal ut and is sent by the scheduler client sc.

The parallel processing method described in the present embodiment is realized by executing a previously prepared program in a computer such as a personal computer or a workstation. The parallel processing program is recorded in a computer-readable recording medium such as a hard disk, a flexible disk, a compact disc-read only memory (CD-ROM), or a digital versatile disk (DVD) and is executed by the computer reading the parallel processing program from the recording medium. In addition, the parallel processing program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A parallel processing system comprising:
three or more node devices including a first node device,
wherein
the first node device is configured to perform an allocation process of a computation resource targeting a processing, the first node device includes a memory and a processor, the processor of the first node device is configured to:
send permission information to each of a plurality of node devices of the three or more node devices, the permission information indicating permission to request the allocation process corresponding in number to a number of processings which the allocation process is able to execute in a unit time using a resource of the first node device in the unit time, the plurality of node devices being set to receive an execution request for the processing, and
the plurality of node devices each include a memory and a processor, each processor of the plurality of node devices is configured to:
when receiving the execution request for the processing, spend the permission indicated by the permission information received from the first node device, and send a request for execution of the allocation process that targets the processing to the first node device.

2. The parallel processing system according to claim 1, wherein
the processor of the first node device is configured to:
send, to the plurality of node devices, identification information that is assigned to a target processing of the allocation process and identifies the target processing, and
the each processor of the plurality of node devices is configured to:
when receiving the execution request for the processing, allocate the identification information received from the first node device to the processing,
send the allocated identification information to a request source of the execution request for the processing,
spend the permission indicated by the permission information, and
send, to the first node device, the request for execution of the allocation process that targets the processing identified by the identification information.

3. The parallel processing system according to claim 2, wherein the each processor of the plurality of node devices is configured to:
when receiving a cancelation request for a process including the identification information, determine whether the request for execution of the allocation process that targets the processing is sent to the first node device, and
when determining that the request for execution of the allocation process that targets the processing is not sent to the first node device, discard the request for execution of the allocation process that targets the processing.

4. The parallel processing system according to claim 2, wherein the each processor of the plurality of node devices is configured to:
when receiving a state display request for a processing including the identification information, determine whether the request for execution of the allocation process that targets the processing is sent to the first node device, and
when determining that the request for execution of the allocation process that targets the processing is not sent to the first node device, send information indicating a computation resource not being allocated to the process to a request source of the state display request.

5. The parallel processing system according to claim 2, wherein
each of the execution request for the processing and the request for execution of the allocation process that targets the processing includes a number of node devices of the three or more node devices to be executed the processing and a time interval of execution of the processing, and
the processor of the first node device is configured to:
store, in the memory of the first node device in accordance with execution of the allocation process in the unit time, the number of node devices executing each processing of a target of the allocation process in the unit time, a time slot of execution of the each processing, and an amount of time taken for the allocation process that targets the each processing,
refer to the number of node devices executing the processing of a target of the allocation process, the time slot of execution of the processing, and the amount of time taken for the allocation process in the memory of the first node device,
specify the amount of time taken for the allocation process targeting the each processing, based on the number of node devices executing each processing of a target of the allocation process executed after the unit time specified from the request for execution of the allocation process received from the plurality of node devices and on the time slot of execution of the each processing, and
determine a number of processings which the allocation process is able to execute in a unit time after the unit time based on the specified amount of time taken for the allocation process that targets the each processing.

6. The parallel processing system according to claim 1, wherein
the permission information received from the first node device is shared among the plurality of node devices.

7. A method executed by a parallel processing system including three or more node devices, the method comprising:
sending, by a processor in a first node device of three or more node devices which is configured to perform an allocation process of a computation resource targeting a processing, permission information to each of a plurality of node devices of the three or more node devices, the permission information indicating permission to request the allocation process corresponding in number to a number of processings which the allocation process is able to execute in a unit time using a resource of the first node device in the unit time, the plurality of node devices being set to receive an execution request for the processing;
spending the permission indicated by the permission information received from the first node device, by each processor of the plurality of node devices, when receiving the execution request for the processing; and
sending, by each processor of the plurality of node devices, a request for execution of the allocation process that targets the processing to the first node device.

8. The method according to claim 7, further comprising:
sending, by the processor of the first node device, identification information that is assigned to a target processing of the allocation process and identifies the target processing to the plurality of node devices;
allocating, by the each processor of the plurality of node devices, the identification information received from the first node device to the processing when receiving the execution request for the processing;
sending, by the each processor of the plurality of node devices, the allocated identification information to a request source of the execution request for the processing;
spending, by the each processor of the plurality of node devices, the permission indicated by the permission information; and
sending, by the each processor of the plurality of node devices, the request for execution of the allocation process that targets the processing identified by the identification information to the first node device.

9. The method according to claim 8, further comprising:
determining, by the each processor of the plurality of node devices, whether the request for execution of the allocation process that targets the processing is sent to the first node device when receiving a cancelation request for a processing including the identification information; and
discarding, by the each processor of the plurality of node devices, the request for execution of the allocation process that targets the processing when determining that the request for execution of the allocation process that targets the processing is not sent to the first node device.

10. The parallel processing system according to claim 8, further comprising:
determining, by the each processor of the plurality of node devices, whether the request for execution of the allocation process that targets the processing is sent to the first node device when receiving a state display request for a processing including the identification information; and
sending, by the each processor of the plurality of node devices, information indicating a computation resource not being allocated to the processing to a request source of the state display request when determining that the request for execution of the allocation process that targets the processing is not sent to the first node device.

11. The parallel processing system according to claim 8, wherein
each of the execution request for the processing and the request for execution of the allocation process that targets the processing includes a number of node devices of the three or more node devices to be executed the processing and a time interval of execution of the processing, and
the method further comprises:
storing, by the processor of the first node device, the number of node devices executing each processing of a target of the allocation process in the unit time, a time slot of execution of each processing, and an amount of time taken for the allocation process that targets the each processing in the memory in accordance with execution of the allocation process in the unit time;
referring to, by the processor of the first node device, the number of node devices executing the processing of a target of the allocation process, the time slot of execution of the processing, and the amount of time taken for the allocation process stored in the memory;
specifying, by the processor of the first node device, the amount of time taken for the allocation process targeting each processing, based on the number of node devices executing each processing of a target of the allocation process executed after the unit time specified from the request for execution of the allocation process received from the plurality of node devices and on the time slot of execution of each processing; and
determining, by the processor of the first node device, a number of processes which the allocation process is able to execute in a unit time after the unit time based on the specified amount of time taken for the allocation process that targets the each processing.

12. The method according to claim 7, wherein
the permission information received from the first node device is shared among the plurality of node devices.

13. A non-transitory storage medium storing a program that causes a node device of three or more node devices in a parallel processing system to execute a process, the process comprising:
in a case where the node device is a first node device configured to perform an allocation process of a computation resource targeting a processing, sending permission information to each of a plurality of node devices of the three or more node devices, the permission information indicating permission to request the allocation process corresponding in number to a number of processings which the allocation process is able to execute in a unit time using a resource of the first node device in the unit time, the plurality of node devices being set to receive an execution request for the processing; and
in a case where the node device is a second node device of the plurality of node devices,
spending the permission indicated by the permission information received from the first node device when receiving the execution request for the processing, and
sending a request for execution of the allocation process that targets the processing to the first node device.

14. The storage medium according to claim 13, wherein the process further comprises:
in a case where the node device is the first node device, sending identification information that is assigned to a target processing of the allocation process and identifies the target processing to the plurality of node devices; and
in a case where the node device is the second node device,
allocating the identification information received from the first node device to the processing when receiving the execution request for the processing,
sending the allocated identification information to a request source of the execution request for the processing,
spending the permission indicated by the permission information, and
sending the request for execution of the allocation process that targets the processing identified by the identification information to the first node device.

15. The storage medium according to claim 14, wherein the process further comprises:
in a case where the node device is the second node device,
determining whether the request for execution of the allocation process that targets the processing is sent to the first node device when receiving a cancelation request for a processing including the identification information, and
discarding the request for execution of the allocation process that targets the processing when determining that the request for execution of the allocation process that targets the processing is not sent to the first node device.

16. The storage medium according to claim 14, wherein the process further comprises:
in a case where the node device is the second node device,
determining whether the request for execution of the allocation process that targets the processing is sent to the first node device when receiving a state display request for a processing including the identification information, and
sending information indicating a computation resource not being allocated to the processing to a request source of the state display request when determining that the request for execution of the allocation process that targets the processing is not sent to the first node device.

17. The storage medium according to claim 14, wherein
each of the execution request for the processing and the request for execution of the allocation process that targets the processing includes a number of node devices of the three or more node devices to be executed the processing and a time interval of execution of the processing, and
the process further comprises:
in a case where the node device is the first node device,
storing the number of node devices executing each processing of a target of the allocation process in the unit time, a time slot of execution of each processing, and an amount of time taken for the allocation process that targets the each processing in the memory in accordance with execution of the allocation process in the unit time,
referring to the number of node devices executing the processing of a target of the allocation process, the time slot of execution of the processing, and the amount of time taken for the allocation process stored in the memory,
specifying the amount of time taken for the allocation process targeting each processing, based on the number of node devices executing each processing of a target of the allocation process executed after the unit time specified from the request for execution of the allocation process received from the plurality of node devices and on the time slot of execution of each processing, and
determining a number of processes which the allocation process is able to execute in a unit time after the unit time based on the specified amount of time taken for the allocation process that targets the each processing.

18. The storage medium according to claim 13, wherein
the permission information received from the first node device is shared among the plurality of node devices.
